(19) United States
(12) Patent Application Publication
(10) Pub. No.: US 2026/0086387 A1
(43) Pub. Date: Mar. 26, 2026

(54) AIR FLOATING VIDEO DISPLAY APPARATUS

(71) Applicant: Maxell, Ltd., Kyoto (JP)

(72) Inventors: Tetsuki NISHIMURA, Kyoto (JP); Koji HIRATA, Kyoto (JP); Koji FUJITA, Kyoto (JP); Yoshiho SEO, Kyoto (JP); Naoyuki OGURA, Kyoto (JP)

(73) Assignee: Maxell, Ltd., Kyoto (JP)

(21) Appl. No.: 19/110,819

(22) PCT Filed: Jul. 14, 2023
(86) PCT No.: PCT/JP2023/026137

§ 371 Date: Mar. 12, 2025

(30) Foreign Application Priority Data
Sep. 21, 2022 (JP) 2022-150305

(51) Int. Cl. G02B 30/56; G02F 1/1335; G02F 1/13363; H04N 13/302

(52) U.S. Cl. CPC G02B 30/56; G02F 1/133512; G02F 1/133638; H04N 13/302

(57) ABSTRACT

A more favorable air floating video display apparatus is provided. According to the present invention, it is possible to contribute to “Goal 3: Ensure healthy lives and promote well-being for all at all ages”, “Goal 9: Build resilient infrastructure, promote inclusive and sustainable industrialization and foster innovation”, and “Goal 11: Make cities and human settlements inclusive, safe, resilient and sustainable” in the Sustainable Development Goals (SDGs). The air floating video display apparatus includes a video display apparatus, a polarization separator, a retroreflection module having a λ/4 plate and a retroreflector, and a housing configured to hold them. In a relationship between a first angle that the video display apparatus forms with respect to the polarization separator and a second angle that the retroreflection module forms with respect to the polarization separator, the second angle is different from the from angle.

### TECHNICAL FIELD

The present invention relates to an air floating video display apparatus.

### BACKGROUND ART

For example, Patent Document 1 discloses an air floating information display technology.

### RELATED ART DOCUMENTS

### Patent Documents

Patent Document 1: Japanese Unexamined Patent Application Publication No. 2019-128722

### SUMMARY OF THE INVENTION

### Problems to be Solved by the Invention

However, in the disclosure of Patent Document 1, sufficient consideration has not been given to the configuration for obtaining practical brightness and quality of an air floating video, the configuration for enabling a user to visually recognize an air floating video more enjoyably, and the like.

An object of the present invention is to provide a more favorable air floating video display apparatus.

### Means for Solving the Problems

In order to solve the problem described above, for example, the configuration described in claims is adopted. Although this application includes a plurality of means for solving the problem described above, one example thereof can be presented as follows. An air floating video display apparatus according to one embodiment is an air floating video display apparatus configured to display an air floating video, and it includes: a video display apparatus; a polarization separator configured to reflect a video light of a specific polarized wave from the video display apparatus and transmit a video light of the other polarized wave; a retroreflection module configured to retroreflect the reflected video light of the specific polarized wave from the polarization separator and convert it into a video light of the other polarized wave and including a λ/4 plate and a retroreflector; and a housing configured to hold the video display apparatus, the polarization separator, and the retroreflection module, the video light of the other polarized wave from the retroreflection module is transmitted through the polarization separator to form the air floating video which is a real image at a predetermined position outside the housing, and in a relationship between a first angle that the video display apparatus forms with respect to the polarization separator and a second angle that the retroreflection module forms with respect to the polarization separator, the second angle is different from the first angle.

### Effects of the Invention

According to the present invention, it is possible to realize a more favorable air floating video display apparatus. Other problems, configurations, and effects will become apparent in the following description of embodiments.

### BRIEF DESCRIPTION OF THE DRAWINGS

FIG. 1 is a diagram illustrating an example of usage form of an air floating video display apparatus according to one embodiment of the present invention.

FIG. 2A is a diagram illustrating an example of a configuration of a main part and a configuration of a retroreflection portion of the air floating video display apparatus according to one embodiment of the present invention.

FIG. 2B is a diagram illustrating an example of a configuration of a main part and a configuration of a retroreflection portion of the air floating video display apparatus according to one embodiment of the present invention.

FIG. 2C is a diagram illustrating an example of configuration of a main part and a configuration of a retroreflection portion of the air floating video display apparatus according to one embodiment of the present invention.

FIG. 3 is a diagram illustrating a configuration example of an air floating video display apparatus according to one embodiment of the present invention.

FIG. 4A is a diagram illustrating an example of the configuration of the air floating video display apparatus according to one embodiment of the present invention.

FIG. 4B is a diagram illustrating an example of the configuration of the air floating video display apparatus according to one embodiment of the present invention.

FIG. 4C is a diagram illustrating an example of the configuration of the air floating video display apparatus according to one embodiment of the present invention.

FIG. 4D is a diagram illustrating an example of the configuration of the air floating video display apparatus according to one embodiment of the present invention.

FIG. 4E is a diagram illustrating an example of the configuration of the air floating video display apparatus according to one embodiment of the present invention.

FIG. 4F is a diagram illustrating an example of the configuration of the air floating video display apparatus according to one embodiment of the present invention.

FIG. 4G is a diagram illustrating an example of the configuration of the air floating video display apparatus according to one embodiment of the present invention.

FIG. 4H is a diagram illustrating an example of the configuration of the air floating video display apparatus according to one embodiment of the present invention.

FIG. 4I is a diagram illustrating an example of the configuration of the air floating video display apparatus according to one embodiment of the present invention.

FIG. 4J is a diagram illustrating an example of the configuration of the air floating video display apparatus according to one embodiment of the present invention.

FIG. 4K is a diagram illustrating an example of the configuration of the air floating video display apparatus according to one embodiment of the present invention.

FIG. 4L is a diagram illustrating an example of the configuration of the air floating video display apparatus according to one embodiment of the present invention.

FIG. 4M is a diagram illustrating an example of the configuration of the air floating video display apparatus according to one embodiment of the present invention.

FIG. 5 is a cross-sectional view illustrating an example of a specific configuration of a light source apparatus according to one embodiment of the present invention.

FIG. 6 is a cross-sectional view illustrating an example of the specific configuration of the light source apparatus according to one embodiment of the present invention.

FIG. 7 is a cross-sectional view illustrating an example of the specific configuration of the light source apparatus according to one embodiment of the present invention.

FIG. 8 is a layout drawing illustrating a main part of the air floating video display apparatus according to one embodiment of the present invention.

FIG. 9 is a cross-sectional view illustrating a configuration of a display apparatus according to one embodiment of the present invention.

FIG. 10 is a cross-sectional view illustrating a configuration of the display apparatus according to one embodiment of the present invention.

FIG. 11 is an explanatory diagram for describing light source diffusion characteristics of the video display apparatus according to one embodiment of the present invention.

FIG. 12 is an explanatory diagram for describing diffusion characteristics of the video display apparatus according to one embodiment of the present invention.

FIG. 13A is an explanatory diagram for a problem of irregular video light of a retroreflection module according to one embodiment of the present invention.

FIG. 13B is an explanatory diagram for the problem of irregular video light of the retroreflection module according to one embodiment of the present invention.

FIG. 13C is an explanatory diagram for a principle of solution according to one embodiment of the present invention.

FIG. 13D is an explanatory diagram for the principle of solution according to one embodiment of the present invention.

FIG. 14A is an explanatory diagram for a problem of irregular video light of the air floating video display apparatus according to one embodiment of the present invention.

FIG. 14B is an explanatory diagram for the problem of irregular video light of the air floating video display apparatus according to one embodiment of the present invention.

FIG. 15A is a diagram illustrating an example (example 1A) of a configuration of the air floating video display apparatus according to one embodiment of the present invention.

FIG. 15B is a diagram illustrating an example (example 1B) of the configuration of the air floating video display apparatus according to one embodiment of the present invention.

FIG. 15C is a diagram illustrating an example (example 1C) of the configuration of the air floating video display apparatus according to one embodiment of the present invention.

FIG. 15D is a diagram illustrating an example (example 1D) of the configuration of the air floating video display apparatus according to one embodiment of the present invention.

FIG. 16A is a diagram illustrating an example (example 2A) of the configuration of the air floating video display apparatus according to one embodiment of the present invention.

FIG. 16B is a diagram illustrating an example (example 2B) of the configuration of the air floating video display apparatus according to one embodiment of the present invention.

FIG. 16C is a diagram illustrating an example (example 2C) of the configuration of the air floating video display apparatus according to one embodiment of the present invention.

FIG. 16D is a diagram illustrating an example (example 2D) of the configuration of the air floating video display apparatus according to one embodiment of the present invention.

FIG. 17A is a diagram illustrating an example (example 3A) of the configuration of the air floating video display apparatus according to one embodiment of the present invention.

FIG. 17B is a diagram illustrating an example (example 3B) of the configuration of the air floating video display apparatus according to one embodiment of the present invention.

FIG. 18A is a diagram illustrating a configuration of a holding unit in an example (example 4A) of the configuration of the air floating video display apparatus according to one embodiment of the present invention.

FIG. 18B is a diagram illustrating a configuration of a holding member in the example (example 4A) of the configuration of the air floating video display apparatus according to one embodiment of the present invention.

FIG. 18C is an explanatory diagram for arrangement angles of the holding members of the holding unit in the example (example 4A) of the configuration of the air floating video display apparatus according to one embodiment of the present invention.

FIG. 18D is a diagram illustrating a state in which the retroreflection module is arranged on one holding member of the holding unit in the example (example 4A) of the configuration of the air floating video display apparatus according to one embodiment of the present invention.

FIG. 18E is a diagram illustrating a state in which the retroreflection module is arranged on the other holding member of the holding unit in the example (example 4A) of the configuration of the air floating video display apparatus according to one embodiment of the present invention.

FIG. 18F is a diagram illustrating a configuration of screw holes in the holding unit in the example (example 4A) of the configuration of the air floating video display apparatus according to one embodiment of the present invention.

FIG. 19A is a diagram illustrating a configuration of a holding unit in an example (example 4B) of the configuration of the air floating video display apparatus according to one embodiment of the present invention.

FIG. 19B is a diagram illustrating a configuration of a holding unit in an example (modification of example 4B) of the configuration of the air floating video display apparatus according to one embodiment of the present invention.

### DETAILED DESCRIPTION OF PREFERRED EMBODIMENTS

Hereinafter, embodiments of the present invention will be described in detail with reference to drawings. Note that the present invention is not limited to the described embodiments, and various changes and modifications can be made by those skilled in the art within the scope of the technical idea disclosed in this specification. Further, in all the drawings for describing the present invention, components having the same function are denoted by the same reference characters, and the repetitive descriptions will be omitted in some cases.

The following embodiments relate to a video display apparatus capable of transmitting a video by video light from a video light emitting source through a transparent member that partitions a space such as a glass and displaying the video as an air floating video outside the transparent member. In the following description of the embodiments, a video floating in the air is expressed by the term “air floating video”. Instead of this term, expressions such as “aerial image”, “space image”, “aerial floating video”, “air floating optical image of a display image”, “aerial floating optical image of a display image”, etc. may be used. The term “air floating video” mainly used in the description of the embodiments is used as a representative example of these terms.

According to the following embodiments, for example, it is possible to realize a video display apparatus suitable for an ATM of a bank, a ticket vending machine of a station, a digital signage, or the like. For example, though a touch panel is generally used in an ATM of a bank, a ticket vending machine of a station, or the like at present, it becomes possible to display high-resolution video information above a transparent glass surface or a light-transmitting plate material in a state of floating in the air. At this time, by making the divergence angle of the emitted video light small, that is, an acute angle, and further aligning the video light with a specific polarized wave, only the normal reflected light is efficiently reflected with respect to the retroreflection plate, so that the light utilization efficiency can be increased, the ghost image which is generated in addition to the main air floating image and is a problem in the conventional retroreflective system can be suppressed, and a clear air floating video can be obtained. Also, with the apparatus including the light source of the present embodiment, it is possible to provide a novel and highly usable air floating video display apparatus (air floating video display system) capable of significantly reducing power consumption. Further, it is also possible to provide an in-vehicle air floating video display apparatus capable of displaying a so-called unidirectional air floating video which can be visually recognized inside and/or outside the vehicle.

### First Embodiment

### <Example of Usage Form of Air Floating Video Display Apparatus>

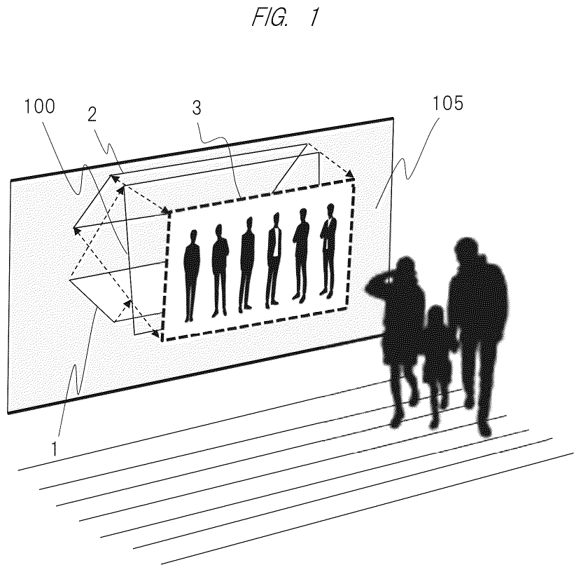

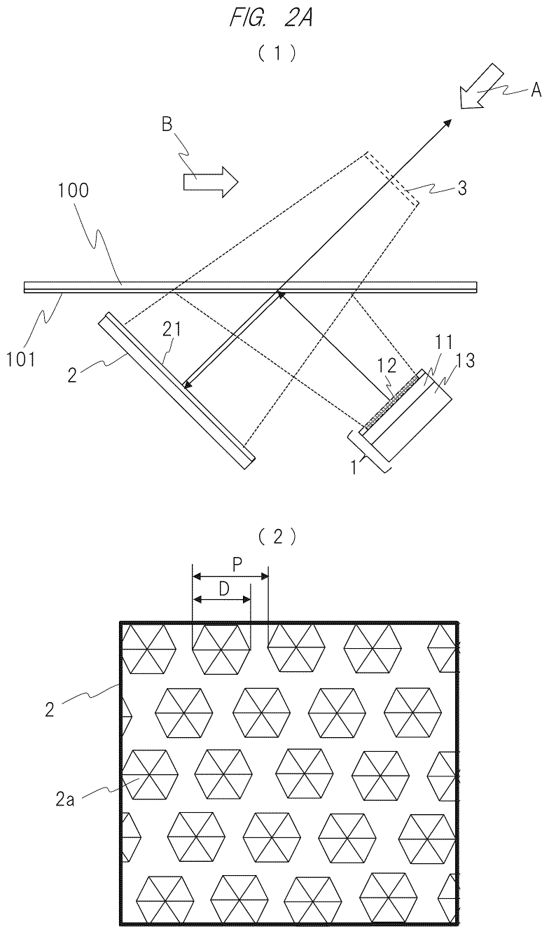

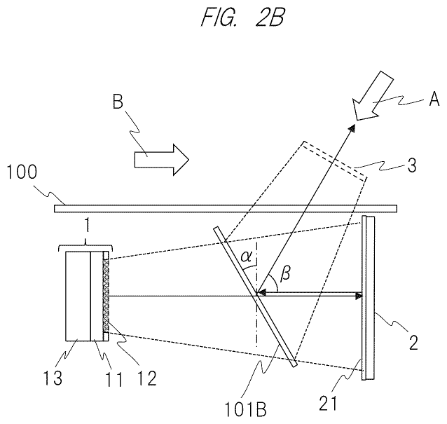

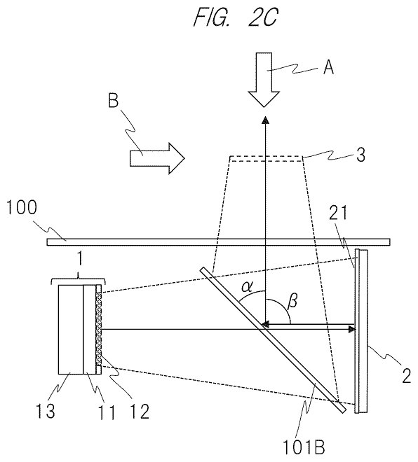

FIG. 1 is a diagram illustrating an example of usage form of an air floating video display apparatus according to one embodiment of the present invention, and is a diagram illustrating an entire configuration of the air floating video display apparatus according to the present embodiment. Although a specific configuration of the air floating video display apparatus will be described in detail with reference to FIG. 2 and the like, light of a specific polarized wave with narrow-angle directional characteristics is emitted from a video display apparatus 1 as a video light flux, once enters a retroreflection plate 2 thorough reflection or the like on an optical system in the air floating video display apparatus, is retroreflected and passes through a transparent member 100 (glass or the like), thereby forming an aerial image (air floating video 3) which is a real image on the outside of the glass surface. In the following description of the embodiments, the retroreflection plate 2 (retroreflective plate) will be used as an example of a retroreflector. However, the retroreflection plate 2 of the present invention is not limited to a planar plate, and is used as an example of a concept including a sheet-like retroreflector attached to a planar or non-planar member or an entire assembly in which a sheet-like retroreflector is attached to a planar or non-planar member made of resin, glass, or the like.

In a store or the like, a space is partitioned by a show window (referred to also as “window glass”) 105 which is a translucent member such as glass. With the air floating video display apparatus of the present embodiment, the floating video can be displayed in one direction to the outside and/or the inside of the store (space) through such a transparent member.

In FIG. 1, the inner side of the window glass 105 (the inside of the store) is illustrated on the far side in the depth direction, and the outer side thereof (e.g., a sidewalk) is illustrated on the near side. On the other hand, it is also possible to form an aerial image at a desired position in the store by providing a reflector configured to reflect a specific polarized wave on the window glass 105 and reflecting the light by the reflector.

### <Configuration Example of Optical System of Air Floating Video Display Apparatus>

FIG. 2A is a diagram illustrating an example of a configuration of an optical system of the air floating video display apparatus according to one embodiment of the present invention. The configuration of the air floating video display apparatus will be described more specifically with reference to FIG. 2A. As illustrated in FIG. 2A(1), the display apparatus 1 which diverges video light of a specific polarized wave at a narrow angle is provided in the oblique direction of the transparent member 100 such as glass. The display apparatus 1 includes a liquid crystal display panel 11 and a light source apparatus 13 configured to generate light of a specific polarized wave having narrow-angle diffusion characteristics.

The video light of a specific polarized wave from the display apparatus 1 is reflected by a polarization separator 101 having a film selectively reflecting the video light of a specific polarized wave and provided on the transparent member 100 (in the drawing, the polarization separator 101 is formed in a sheet shape and is adhered to the transparent member 100), and enters the retroreflection plate 2. A λ/4 plate 21 is provided on the video light incident surface of the retroreflection plate 2. The video light passes through the λ/4 plate 21 twice at the time when the video light enters the retroreflection plate 2 and at the time when the video light is emitted from the retroreflection plate 2, whereby the video light is subjected to polarization conversion from a specific polarized wave to the other polarized wave. Here, since the polarization separator 101 which selectively reflects the video light of a specific polarized wave has a property of transmitting the polarized light of the other polarized wave subjected to the polarization conversion, the video light of the specific polarized wave after the polarization conversion passes through the polarization separator 101. The video light that has passed through the polarization separator 101 forms the air floating video 3, which is a real image, on the outside of the transparent member 100.

Here, a first example of a polarization design in the optical system in FIG. 2A will be described. For example, the configuration in which the video light of S polarization is emitted from the display apparatus 1 to the polarization separator 101 and the polarization separator 101 has the property of reflecting S polarization and transmitting P polarization is also possible. In this case, the video light of S polarization that has reached the polarization separator 101 from the display apparatus 1 is reflected by the polarization separator 101 and is directed toward the retroreflection plate 2. Since the video light passes through the λ/4 plate 21 provided on the incident surface of the retroreflection plate 2 twice when the video light is reflected by the retroreflection plate 2, the video light is converted from S-polarized light into P-polarized light. The video light converted into P-polarized light is directed toward the polarization separator 101 again. Here, since the polarization separator 101 has the property of reflecting S polarization and transmitting P polarization, the video light of P polarization passes through the polarization separator 101 and then passes through the transparent member 100. Since the video light that has passed through the transparent member 100 is the light generated by the retroreflection plate 2, the air floating video 3 which is an optical image of the displayed video of the display apparatus 1 is formed at a position having a mirror relationship with the displayed video of the display apparatus 1 with respect to the polarization separator 101. With the polarization design described above, the air floating video 3 can be favorably formed.

Next, a second example of the polarization design in the optical system in FIG. 2A will be described. For example, the configuration in which the video light of P polarization is emitted from the display apparatus 1 to the polarization separator 101 and the polarization separator 101 has the property of reflecting P polarization and transmitting S polarization is also possible. In this case, the video light of P polarization that has reached the polarization separator 101 from the display apparatus 1 is reflected by the polarization separator 101 and is directed toward the retroreflection plate 2. Since the video light passes through the λ/4 plate 21 provided on the incident surface of the retroreflection plate 2 twice when the video light is reflected by the retroreflection plate 2, the video light is converted from P-polarized light into S-polarized light. The video light converted into S-polarized light is directed toward the polarization separator 101 again. Here, since the polarization separator 101 has the property of reflecting P polarization and transmitting S polarization, the video light of S polarization passes through the polarization separator 101 and then passes through the transparent member 100. Since the video light that has passed through the transparent member 100 is the light generated by the retroreflection plate 2, the air floating video 3 which is an optical image of the displayed video of the display apparatus 1 is formed at a position having a mirror relationship with the displayed video of the display apparatus 1 with respect to the polarization separator 101. With the polarization design described above, the air floating video 3 can be favorably formed.

Note that the light that forms the air floating video 3 is a set of light rays converging from the retroreflection plate 2 to the optical image of the air floating video 3, and these light rays go straight even after passing through the optical image of the air floating video 3. Therefore, the air floating video 3 is a video having high directivity, unlike diffused video light formed on a screen by a general projector or the like. Therefore, in the configuration of FIG. 2A, when the user visually recognizes the air floating video 3 from the direction of an arrow A, the air floating video 3 is visually recognized as a bright video. However, when another person visually recognizes the video from the direction of an arrow B, the air floating video 3 cannot be visually recognized as a video at all. These characteristics are very suitable for use in a system that displays a video requiring high security or a highly confidential video that is desired to be kept secret from a person facing the user.

Note that, depending on the performance of the retroreflection plate 2, the polarization axes of the video light after the reflection may become uneven, and the reflection angles may also become uneven. Such uneven light does not maintain the polarization state and traveling angle assumed in design in some cases. For example, such light with the polarization state and traveling angle that are not assumed in design may directly enter the video display surface of the liquid crystal display panel 11 again from the position of the retroreflection plate 2 without passing through the polarization separator. Also, such light with the polarization state and traveling angle that are not assumed in design may enter the video display surface of the liquid crystal display panel 11 again after being reflected by components in the air floating video display apparatus. The light that has entered the video display surface of the liquid crystal display panel 11 again is reflected again on the video display surface of the liquid crystal display panel 11 constituting the display apparatus 1, so that a ghost image is generated and the image quality of the air floating image is deteriorated in some cases. Thus, in the present embodiment, an absorptive polarization plate 12 may be provided on the video display surface of the display apparatus 1. The video light emitted from the display apparatus 1 is transmitted through the absorptive polarization plate 12, and the reflected light returning from the polarization separator 101 is absorbed by the absorptive polarization plate 12, whereby the re-reflection described above can be suppressed. In this way, it is possible to prevent deterioration in image quality due to a ghost image of an air floating image. Specifically, in the configuration in which the video light of S polarization is emitted from the display apparatus 1 to the polarization separator 101, the polarization plate that absorbs P-polarized light can be used as the absorptive polarization plate 12. Also, in the configuration in which the video light of P polarization is emitted from the display apparatus 1 to the polarization separator 101, the polarization plate that absorbs S-polarized light can be used as the absorptive polarization plate 12.

The polarization separator 101 described above may be formed of, for example, a reflective polarization plate or a metal multilayer film that reflects a specific polarized wave.

Then, FIG. 2A(2) illustrates a surface shape of a retroreflection plate manufactured by Nippon Carbide Industries Co., Inc. used in this study as the typical retroreflection plate 2. The light ray that enters regularly arranged hexagonal columns is reflected by the wall surfaces and bottom surfaces of the hexagonal columns and emitted as retroreflected light in a direction corresponding to the incident light, and an air floating video which is a real image is displayed based on the video displayed on the display apparatus 1.

The resolution of the air floating image largely depends on the outer shape D and pitch P of the retroreflection portions of the retroreflection plate 2 illustrated in FIG. 2A(2), in addition to the resolution of the liquid crystal display panel 11. For example, when a 7-inch WUXGA (1920×1200 pixels) liquid crystal display panel is used, even if one pixel (one triplet) is about 80 μm, one pixel of the air floating image is about 300 μm if the diameter D of the retroreflection portion is 240 μm and the pitch is 300 μm, for example. Therefore, the effective resolution of the air floating video is reduced to about ⅓.

Therefore, in order to make the resolution of the air floating video equal to the resolution of the display apparatus 1, it is desired that the diameter and the pitch of the retroreflection portions are close to one pixel of the liquid crystal display panel. On the other hand, in order to suppress the occurrence of moire caused by the retroreflection plate and the pixels of the liquid crystal display panel, it is preferable to design each pitch ratio so as not to be an integral multiple of one pixel. Further, the shape is preferably arranged such that any one side of the retroreflection portion does not overlap with any one side of one pixel of the liquid crystal display panel.

Note that the surface shape of the retroreflection plate according to the present embodiment is not limited to the above example, and the retroreflection plate may have a variety of surface shapes to realize the retroreflection. Specifically, a retroreflective element in which triangular pyramidal prisms, hexagonal pyramidal prisms, other polygonal prisms, or combinations thereof are regularly arranged may be provided on the surface of the retroreflection plate of the present embodiment. Alternatively, a retroreflective element in which these prisms are regularly arranged to form cube corners may be provided on the surface of the retroreflection plate of the present embodiment. Moreover, a capsule-lens retroreflection element in which glass beads are regularly arranged may be provided on the surface of the retroreflection plate of the present embodiment. Since existing techniques can be used for the detailed configurations of these retroreflective elements, detailed description thereof will be omitted. Specifically, it is possible to use the techniques disclosed in Japanese Unexamined Patent Application Publications No. 2001-33609, No. 2001-264525, No. 2005-181555, No. 2008-70898, No. 2009-229942, and others.

### <Another Configuration Example (1) of Optical System of Air Floating Video Display Apparatus>

Another configuration example of the optical system of the air floating video display apparatus will be described with reference to FIG. 2B. Note that it is assumed that components in FIG. 2B denoted by the same reference characters as those in FIG. 2A have the same functions and configurations as those in FIG. 2A. The repetitive descriptions for such components will be omitted to simplify the description.

In the optical system in FIG. 2B, video light of a specific polarized wave is output from the display apparatus 1 as with FIG. 2A. The video light of a specific polarized wave output from the display apparatus 1 is input to a polarization separator 101B. The polarization separator 101B is a member that selectively transmits video light of a specific polarized wave. Unlike the polarization separator 101 in FIG. 2A, the polarization separator 101B is not integrated with the transparent member 100 but has a plate-like shape independently. Therefore, the polarization separator 101B may be expressed as a polarization separation plate. For example, the polarization separator 101B may be configured as a reflective polarization plate obtained by attaching a polarization separation sheet on a transparent member. Alternatively, the polarization separator 101B may be formed by attaching a metal multilayer film that selectively transmits a specific polarized wave and reflects the other specific polarized wave, on a transparent member. In FIG. 2B, the polarization separator 101B is configured so as to transmit the video light of a specific polarized wave output from the display apparatus 1.

The video light that has passed through the polarization separator 101B enters the retroreflection plate 2. The λ/4 plate 21 is provided on the video light incident surface of the retroreflection plate. The video light is subjected to polarization conversion from a specific polarized wave to the other polarized wave by passing through the λ/4 plate 21 twice at the time when it enters the retroreflection plate and at the time when it is emitted therefrom. Here, since the polarization separator 101B has a property of reflecting the light of the other polarized wave that has been subjected to the polarization conversion by the λ/4 plate 21, the video light after the polarization conversion is reflected by the polarization separator 101B. The video light reflected by the polarization separator 101B passes through the transparent member 100, and forms the air floating video 3 which is a real image outside the transparent member 100.

Here, a first example of polarization design in the optical system in FIG. 2B will be described. For example, the configuration in which the video light of P polarization is emitted from the display apparatus 1 to the polarization separator 101B and the polarization separator 101B has a property of reflecting S polarization and transmitting P polarization is also possible. In this case, the video light of P polarization that has reached the polarization separator 101B from the display apparatus 1 passes through the polarization separator 101B and travels toward the retroreflection plate 2. Since the video light passes through the λ/4 plate 21 provided on the incident surface of the retroreflection plate 2 twice when it is reflected by the retroreflection plate 2, the video light is converted from P-polarized light to S-polarized light. The video light converted into S-polarized light is directed to the polarization separator 101B again. Here, since the polarization separator 101B has a property of reflecting S polarization and transmitting P polarization, the video light of S polarization is reflected by the polarization separator 101 and passes through the transparent member 100. Since the video light that has passed through the transparent member 100 is the light generated by the retroreflection plate 2, the air floating video 3 which is an optical image of the displayed video of the display apparatus 1 is formed at a position having a mirror relationship with the displayed image of the display apparatus 1 with respect to the polarization separator 101B. With the polarization design described above, the air floating video 3 can be favorably formed.

Next, a second example of a polarization design in the optical system in FIG. 2B will be described. For example, the configuration in which the video light of S polarization is emitted from the display apparatus 1 to the polarization separator 101B and the polarization separator 101B has the property of reflecting P polarization and transmitting S polarization is also possible. In this case, the video light of S polarization that has reached the polarization separator 101B from the display apparatus 1 passes through the polarization separator 101B and is directed toward the retroreflection plate 2. Since the video light passes through the λ/4 plate 21 provided on the incident surface of the retroreflection plate 2 twice when the video light is reflected by the retroreflection plate 2, the video light is converted from S-polarized light into P-polarized light. The video light converted into P-polarized light is directed toward the polarization separator 101B again. Here, since the polarization separator 101B has the property of reflecting P polarization and transmitting S polarization, the video light of P polarization is reflected by the polarization separator 101 and then passes through the transparent member 100. Since the video light that has passed through the transparent member 100 is the light generated by the retroreflection plate 2, the air floating video 3 which is an optical image of the displayed video of the display apparatus 1 is formed at a position having a mirror relationship with the displayed video of the display apparatus 1 with respect to the polarization separator 101B. With the polarization design described above, the air floating video 3 can be favorably formed.

In FIG. 2B, the video display surface of the display apparatus 1 and the surface of the retroreflection plate 2 are arranged parallel to each other. The polarization separator 101B is arranged so as to be inclined at an angle α (for example, 30°) with respect to the video display surface of the display apparatus 1 and the surface of the retroreflection plate 2. Then, in the reflection by the polarization separator 101B, the traveling direction of the video light reflected by the polarization separator 101B (direction of principal light ray of the video light) differs by an angle β (for example, 60°) from the traveling direction of the video light emitted from the retroreflection plate 2 (direction of principal light ray of the video light). With this configuration, in the optical system in FIG. 2B, the video light is output at a predetermined angle illustrated in the drawing toward the outside of the transparent member 100, and the air floating video 3 which is a real image is formed. In the configuration of FIG. 2B, when the user visually recognizes the air floating video 3 from the direction of an arrow A, the air floating video 3 is visually recognized as a bright video. However, when another person visually recognizes the video from the direction of an arrow B, the air floating video 3 cannot be visually recognized as a video at all. These characteristics are particularly suitable for use in a system that displays a video requiring high security or a highly confidential video that is desired to be kept secret from a person facing the user.

As described above, although the optical system in FIG. 2B has a different configuration from the optical system in FIG. 2A, it is possible to form a favorable air floating video like the optical system in FIG. 2A.

Note that it is also possible to provide an absorptive polarization plate on the surface of the transparent member 100 on the side closer to the polarization separator 101B. As the absorptive polarization plate, an absorptive polarization plate that transmits the polarized wave of the video light from the polarization separator 101B and absorbs the polarized wave whose phase is different by 90° from the polarized wave of the video light from the polarization separator 101B can be provided. In this way, the external light that enters the transparent member 100 from the side of the air floating video 3 can be reduced by about 50%, while sufficiently transmitting the video light for forming the air floating video 3. As a result, it is possible to reduce stray light in the optical system in FIG. 2B due to external light entering the transparent member 100 from the side of the air floating video 3.

### <Another Configuration Example (2) of Optical System of Air Floating Video Display Apparatus>

Another configuration example of the optical system of the air floating video display apparatus will be described with reference to FIG. 2C. Note that it is assumed that components in FIG. 2C denoted by the same reference characters as those in FIG. 2B have the same functions and configurations as those in FIG. 2B. The repetitive descriptions for such components will be omitted to simplify the description.

The optical system in FIG. 2C is different from the optical system in FIG. 2B only in the arrangement angle of the polarization separator 101B with respect to the video display surface of the display apparatus 1 and the surface of the retroreflection plate 2. All of the other configurations are the same as those of the optical system in FIG. 2B, and thus the repetitive descriptions will be omitted. The polarization design of the optical system in FIG. 2C is also similar to the polarization design of the optical system in FIG. 2B, and thus the repetitive descriptions will be omitted.

In the optical system in FIG. 2C, the polarization separator 101B is arranged so as to be inclined at an angle α with respect to the video display surface of the display apparatus 1 and the surface of the retroreflection plate 2. In FIG. 2C, the angle α is 45°. With this configuration, in the reflection of the polarization separator 101B, the angle β formed by the traveling direction of the video light reflected by the polarization separator 101B (direction of principal light ray of the video light) with respect to the traveling direction of the video light entering from the retroreflection plate 2 (direction of principal light ray of the video light) is 90°. As a result, the video display surface of the display apparatus 1 and the surface of the retroreflection plate 2 are in a perpendicular relationship with the traveling direction of the video light reflected by the polarization separator 101B, and the angular relationship of the surfaces constituting the optical system can be simplified. The angular relationship of the surfaces constituting the optical system can be more simplified if the surface of the transparent member 100 is arranged so as to be orthogonal to the traveling direction of the video light reflected by the polarization separator 101B. In the configuration of FIG. 2C, when the user visually recognizes the air floating video 3 from the direction of an arrow A, the air floating video 3 is visually recognized as a bright video. However, when another person visually recognizes the video from the direction of an arrow B, the air floating video 3 cannot be visually recognized as a video at all. These characteristics are particularly suitable for use in a system that displays a video requiring high security or a highly confidential video that is desired to be kept secret from a person facing the user.

As described above, although the optical system in FIG. 2C has a different configuration from the optical systems in FIG. 2A and FIG. 2B, it is possible to form a favorable air floating video like the optical systems in FIG. 2A and FIG. 2B. Furthermore, the angles of the surfaces constituting the optical system can be simplified.

Note that it is also possible to provide an absorptive polarization plate on the surface of the transparent member 100 on the side closer to the polarization separator 101B. As the absorptive polarization plate, an absorptive polarization plate that transmits the polarized wave of the video light from the polarization separator 101B and absorbs the polarized wave whose phase is different by 90° from the polarized wave of the video light from the polarization separator 101B can be provided. In this way, the external light that enters the transparent member 100 from the side of the air floating video 3 can be reduced by about 50%, while sufficiently transmitting the video light for forming the air floating video 3. As a result, it is possible to reduce stray light in the optical system in FIG. 2C due to external light entering the transparent member 100 from the side of the air floating video 3.

According to the optical systems in FIG. 2A, FIG. 2B, and FIG. 2C described above, it is possible to provide a brighter higher-quality air floating video.

### <<Block Diagram of Internal Configuration of Air Floating Video Display Apparatus>>

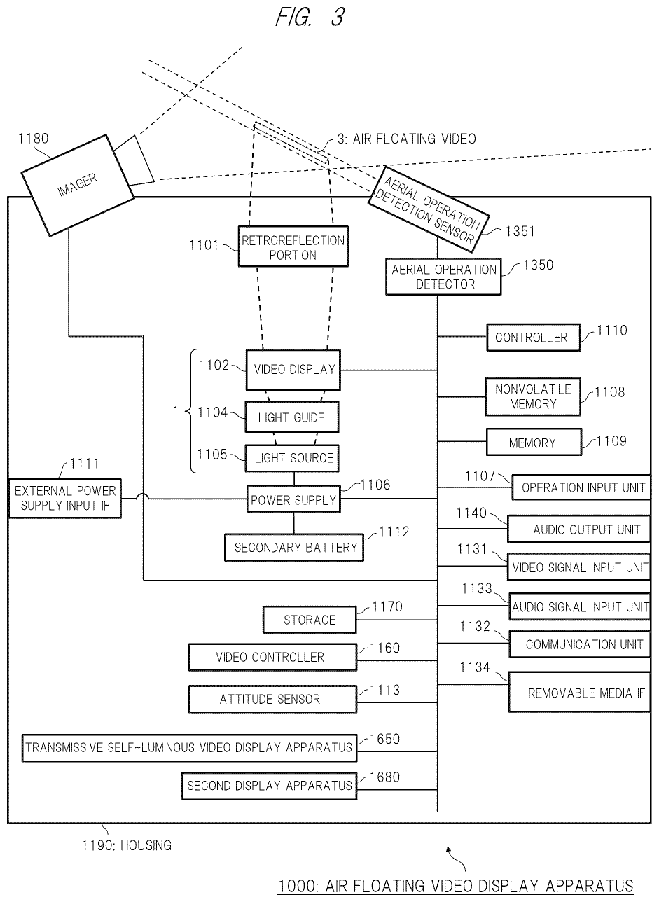

Next, a block diagram of an internal configuration of an air floating video display apparatus 1000 will be described. FIG. 3 is a block diagram illustrating an example of an internal configuration of the air floating video display apparatus 1000.

The air floating video display apparatus 1000 includes a retroreflection portion 1101, a video display 1102, a light guide 1104, a light source 1105, a power supply 1106, an external power supply input interface 1111, an operation input unit 1107, a nonvolatile memory 1108, a memory 1109, a controller 1110, a video signal input unit 1131, an audio signal input unit 1133, a communication unit 1132, an aerial operation detection sensor 1351, an aerial operation detector 1350, an audio output unit 1140, a video controller 1160, a storage 1170, an imager 1180, and the like. Note that the air floating video display apparatus 1000 may include a removable media interface 1134, an attitude sensor 1113, a transmissive self-luminous video display apparatus 1650, a second display apparatus 1680, a secondary battery 1112, and the like.

Each component of the air floating video display apparatus 1000 is arranged in a housing 1190. Note that the imager 1180 and the aerial operation detection sensor 1351 illustrated in FIG. 3 may be provided outside the housing 1190.

The retroreflection portion 1101 in FIG. 3 corresponds to the retroreflection plate 2 in FIG. 2A, FIG. 2B, and FIG. 2C. The retroreflection portion 1101 retroreflects the light modulated by the video display 1102. Of the reflected light from the retroreflection portion 1101, the light output to the outside of the air floating video display apparatus 1000 forms the air floating video 3.

The video display 1102 in FIG. 3 corresponds to the liquid crystal display panel 11 in FIG. 2A, FIG. 2B, and FIG. 2C. The light source 1105 in FIG. 3 corresponds to the light source apparatus 13 in FIG. 2A, FIG. 2B, and FIG. 2C. Further, the video display 1102, the light guide 1104, and the light source 1105 in FIG. 3 correspond to the display apparatus 1 in FIG. 2A, FIG. 2B, and FIG. 2C.

The video display 1102 is a display that generates a video by modulating transmitted light based on a video signal input under the control of the video controller 1160 to be described below. The video display 1102 corresponds to the liquid crystal display panel 11 in FIG. 2A, FIG. 2B, and FIG. 2C. As the video display 1102, for example, a transmissive liquid crystal panel is used. Alternatively, as the video display 1102, for example, a reflective liquid crystal panel using a method of modulating reflected light, a DMD (Digital Micromirror Device: registered trademark) panel, or the like may be used.

The light source 1105 is configured to generate light for the video display 1102, and is a solid-state light source such as an LED light source or a laser light source. The power supply 1106 converts an AC current input from the outside through the external power supply input interface 1111 into a DC current, and supplies power to the light source 1105. Further, the power supply 1106 supplies a necessary DC current to each unit in the air floating video display apparatus 1000. The secondary battery 1112 stores power supplied from the power supply 1106. Also, the secondary battery 1112 supplies power to the light source 1105 and other configurations that require power when power is not supplied from outside via the external power supply input interface 1111. In other words, when the air floating video display apparatus 1000 includes the secondary battery 1112, the user can use the air floating video display apparatus 1000 even when power is not supplied from outside.

The light guide 1104 guides the light generated by the light source 1105 and irradiates the video display 1102 with the light. A combination of the light guide 1104 and the light source 1105 may be referred to also as a backlight of the video display 1102. The light guide 1104 may have a configuration mainly made of glass. The light guide 1104 may have a configuration mainly made of plastic. The light guide 1104 may have a configuration using a mirror. Various configurations are possible as the combination of the light guide 1104 and the light source 1105. A specific configuration example of the combination of the light guide 1104 and the light source 1105 will be described later in detail.

The aerial operation detection sensor 1351 is a sensor that detects an operation on the air floating video 3 by a finger of a user 230. For example, the aerial operation detection sensor 1351 senses a range overlapping with the entire display range of the air floating video 3. Note that the aerial operation detection sensor 1351 may sense only a range overlapping with at least a part of the display range of the air floating video 3.

Specific examples of the aerial operation detection sensor 1351 include a distance sensor using invisible light such as infrared light, an invisible light laser, an ultrasonic wave, or the like. Also, the aerial operation detection sensor 1351 may be configured to be able to detect coordinates on a two-dimensional plane by combining a plurality of sensors. Further, the aerial operation detection sensor 1351 may be composed of a ToF (Time of Flight) type LiDAR (Light Detection and Ranging) or an image sensor.

The aerial operation detection sensor 1351 is not particularly limited as long as it can perform sensing for detecting a touch operation or the like on an object displayed as the air floating video 3 by a finger of the user. Such sensing can be performed by using an existing technique.

The aerial operation detector 1350 acquires a sensing signal from the aerial operation detection sensor 1351, and determines whether or not the finger of the user 230 has touched an object in the air floating video 3 and calculates the position (touch position) where the finger of the user 230 has touched the object, based on the sensing signal. The aerial operation detector 1350 is composed of, for example, a circuit such as a FPGA (Field Programmable Gate Array). Also, a part of the functions of the aerial operation detector 1350 may be implemented by software, for example, by a program for aerial operation detection executed by the controller 1110.

The aerial operation detection sensor 1351 and the aerial operation detector 1350 may be built in the air floating video display apparatus 1000, or may be provided outside separately from the air floating video display apparatus 1000. When provided separately from the air floating video display apparatus 1000, the aerial operation detection sensor 1351 and the aerial operation detector 1350 are configured to be able to transmit information and signals to the air floating video display apparatus 1000 via a wired or wireless communication connection path or video signal transmission path.

Also, the aerial operation detection sensor 1351 and the aerial operation detector 1350 may be provided separately. In this way, it is possible to construct a system in which the air floating video display apparatus 1000 without the aerial operation detection function is provided as a main body and only the aerial operation detection function can be added as an option. Further, the configuration in which only the aerial operation detection sensor 1351 is provided separately and the aerial operation detector 1350 is built in the air floating video display apparatus 1000 is also possible. In a case such as when it is desired to arrange the aerial operation detection sensor 1351 more freely with respect to the installation position of the air floating video display apparatus 1000, the configuration in which only the aerial operation detection sensor 1351 is provided separately is advantageous.

The imager 1180 is a camera having an image sensor, and is configured to capture the image of the space near the air floating video 3 and/or the face, arms, fingers, and the like of the user 230. A plurality of imagers 1180 may be provided. By using a plurality of imagers 1180 or by using an imager with a depth sensor, it is possible to assist the aerial operation detector 1350 in the detection processing of the touch operation on the air floating video 3 by the user 230. The imager 1180 may be provided separately from the air floating video display apparatus 1000. When the imager 1180 is provided separately from the air floating video display apparatus 1000, the imager 1180 may be configured to be able to transmit imaging signals to the air floating video display apparatus 1000 via a wired or wireless communication connection path or the like.

For example, when the aerial operation detection sensor 1351 is configured as an object intrusion sensor that detects whether or not an object has intruded a plane (intrusion detection plane) including the display plane of the air floating video 3, the aerial operation detection sensor 1351 may not be able to detect information indicating how far an object (e.g., a finger of the user) that has not intruded the intrusion detection plane is away from the intrusion detection plane or how close the object is to the intrusion detection plane.

In such a case, it is possible to calculate the distance between the object and the intrusion detection plane by using information such as depth calculation information of the object based on the captured images of the plurality of imagers 1180 or depth information of the object by the depth sensor. Further, these pieces of information and various kinds of information such as the distance between the object and the intrusion detection plane are used for various kinds of display control for the air floating video 3.

Alternatively, the aerial operation detector 1350 may detect a touch operation on the air floating video 3 by the user 230 based on the image captured by the imager 1180 without using the aerial operation detection sensor 1351.

Further, the imager 1180 may capture an image of the face of the user 230 who operates the air floating video 3, and the controller 1110 may perform the identification processing of the user 230. Also, in order to determine whether or not another person is standing around or behind the user 230 who operates the air floating video 3 and the person is peeking at the operation of the user 230 on the air floating video 3, the imager 1180 may capture an image of a range including the user 230 who operates the air floating video 3 and the surrounding region of the user 230.

The operation input unit 1107 is, for example, an operation button or a signal receiver or an infrared receiver such as a remote controller, and receives an input of a signal regarding an operation different from the aerial operation (touch operation) by the user 230. The operation input unit 1107 may be used by, for example, an administrator to operate the air floating video display apparatus 1000 apart from the above-described user 230 who performs the touch operation on the air floating video 3.

The video signal input unit 1131 is connected to an external video output unit and receives an input of video data. Various digital video input interfaces may be used as the video signal input unit 1131. For example, the video signal input unit 1131 can be configured by a video input interface of the HDMI (High-Definition Multimedia Interface (registered trademark)) standard, a video input interface of the DVI (Digital Visual Interface) standard, or a video input interface of the DisplayPort standard. Alternatively, an analog video input interface such as analog RGB or composite video may be provided. The audio signal input unit 1133 is connected to an external audio output unit and receives an input of audio data. The audio signal input unit 1133 can be configured by an audio input interface of the HDMI standard, an optical digital terminal interface, a coaxial digital terminal interface, or the like. In the case of the interface of the HDMI standard, the video signal input unit 1131 and the audio signal input unit 1133 may be configured as an interface having integrated terminal and cable. The audio output unit 1140 can output audio based on the audio data input to the audio signal input unit 1133. The audio output unit 1140 may be configured by a speaker. Also, the audio output unit 1140 may output a built-in operation sound or error warning sound. Alternatively, a configuration to output a digital signal to an external device like the Audio Return Channel function specified in the HDMI standard may be adopted as the audio output unit 1140.

The nonvolatile memory 1108 stores various kinds of data used in the air floating video display apparatus 1000. The data stored in the nonvolatile memory 1108 include, for example, data for various operations to be displayed in the air floating video 3, display icons, data of objects to be operated by user, layout information, and the like. The memory 1109 stores video data to be displayed as the air floating video 3, data for controlling the apparatus, and the like.

The controller 1110 controls the operation of each unit connected thereto. Also, the controller 1110 may perform arithmetic operation based on information acquired from each unit in the air floating video display apparatus 1000 in cooperation with a program stored in the memory 1109.

The communication unit 1132 communicates with an external device, an external server, or the like via a wired or wireless communication interface. When the communication unit 1132 has a wired communication interface, the wired communication interface may be configured by, for example, the LAN interface of the Ethernet standard. When the communication unit 1132 has a wireless communication interface, the wireless communication interface may be configured by, for example, the communication interface of the Wi-Fi standard, the communication interface of the Bluetooth standard, or the 4G or 5G mobile communication interface. Various kinds of data such as video data, image data, and audio data are transmitted and received through communication via the communication unit 1132.

Further, the removable media interface 1134 is an interface configured to connect removable recording media (removable media). The removable recording media (removable media) may be configured by a semiconductor memory such as solid state drive (SSD), a magnetic recording storage device such as hard disk drive (HDD), or an optical recording media such as an optical disc. The removable media interface 1134 can read various kinds of information such as video data, image data, audio data, and others recorded in the removable recording media. The video data, image data, and others recorded in the removable recording media are output as the air floating video 3 via the video display 1102 and retroreflection portion 1101.

The storage 1170 is a storage device that records various kinds of information, for example, various kinds of data such as video data, image data, and audio data. The storage 1170 may be configured by a magnetic recording storage device such as a hard disk drive (HDD), a semiconductor element memory such as a solid state drive (SSD), or the like. In the storage 1170, for example, various kinds of information, for example, various kinds of data such as video data, image data, and audio data may be recorded in advance at the time of product shipment. In addition, the storage 1170 may record various kinds of information, for example, various kinds of data such as video data, image data, and audio data acquired from an external device, an external server, or the like via the communication unit 1132.

The video data, the image data, and the like recorded in the storage 1170 are output as the air floating video 3 via the video display 1102 and the retroreflection portion 1101. Video data, image data, and the like of display icons, an object to be operated by a user, and the like which are displayed as the air floating video 3 are also recorded in the storage 1170.

Layout information of display icons, an object, and the like displayed as the air floating video 3, information of various kinds of metadata related to the object, and the like are also recorded in the storage 1170. The audio data recorded in the storage 1170 is output as audio from, for example, the audio output unit 1140.

The video controller 1160 performs various kinds of control related to a video signal to be input to the video display 1102. The video controller 1160 may be referred to as a video processing circuit, and may be configured by hardware such as ASIC, FPGA, or video processor. Note that the video controller 1160 may be referred to also as a video processing unit or an image processing unit. For example, the video controller 1160 performs the control of video switching for determining which of a video signal stored in the memory 1109 or a video signal (video data) input to the video signal input unit 1131 is to be input to the video display 1102.

Also, the video controller 1160 may perform the control to form a composite video as the air floating video 3 by generating a superimposed video signal obtained by superimposing the video signal stored in the memory 1109 and the video signal input from the video signal input unit 1131 and inputting the superimposed video signal to the video display 1102.

Further, the video controller 1160 may perform the control to perform image processing on the video signal input from the video signal input unit 1131, the video signal to be stored in the memory 1109, or the like. Examples of the image processing include scaling processing for enlarging, reducing, and deforming an image, brightness adjustment processing for changing luminance, contrast adjustment processing for changing a contrast curve of an image, and retinex processing for decomposing an image into light components and changing weighting for each component.

In addition, the video controller 1160 may perform special effect video processing or the like for assisting an aerial operation (touch operation) of the user 230 to the video signal to be input to the video display 1102. The special effect video processing is performed based on, for example, the detection result of the touch operation of the user 230 by the aerial operation detector 1350 and the captured image of the user 230 by the imager 1180.

The attitude sensor 1113 is a sensor configured by a gravity sensor, an acceleration sensor, or a combination thereof, and can detect the attitude with which the air floating video display apparatus 1000 is installed. Based on the attitude detection result of the attitude sensor 1113, the controller 1110 may control the operation of each connected unit. For example, when an unfavorable attitude as the usage state of the user is detected, control to stop the display of the video displayed on the video display 1102 and display an error message to the user may be performed. Alternatively, when the attitude sensor 1113 detects that the installation attitude of the air floating video display apparatus 1000 has changed, control to rotate the display direction of the video displayed on the video display 1102 may be performed.

As described above, the air floating video display apparatus 1000 is provided with various functions. However, the air floating video display apparatus 1000 does not need to have all of these functions, and may have any configuration as long as the apparatus has a function of forming the air floating video 3.

### <Configuration Example of Air Floating Video Display Apparatus>

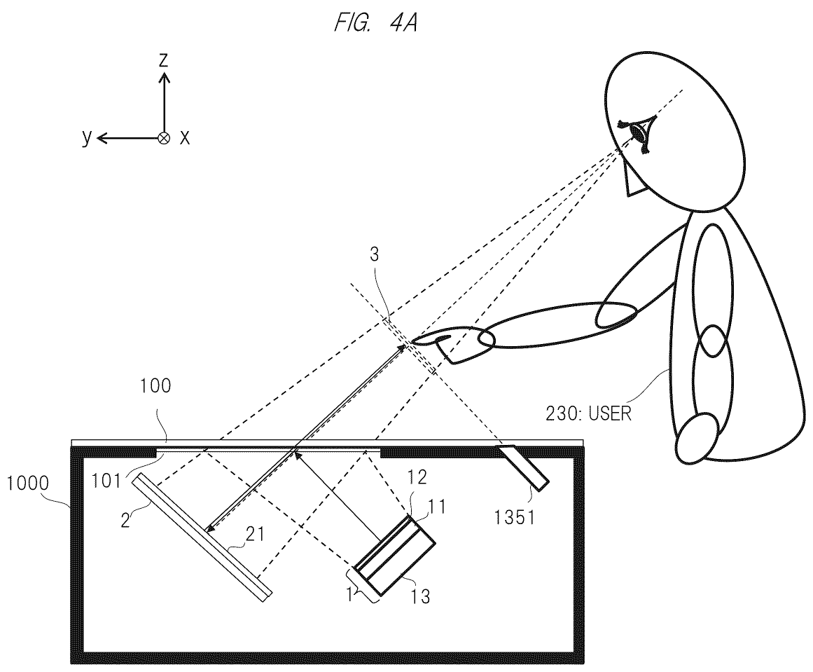

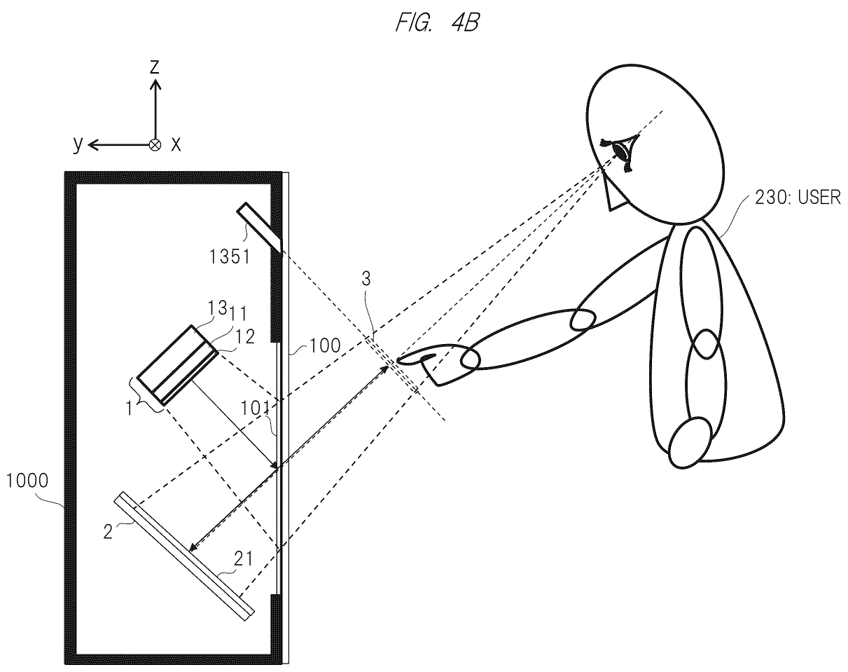

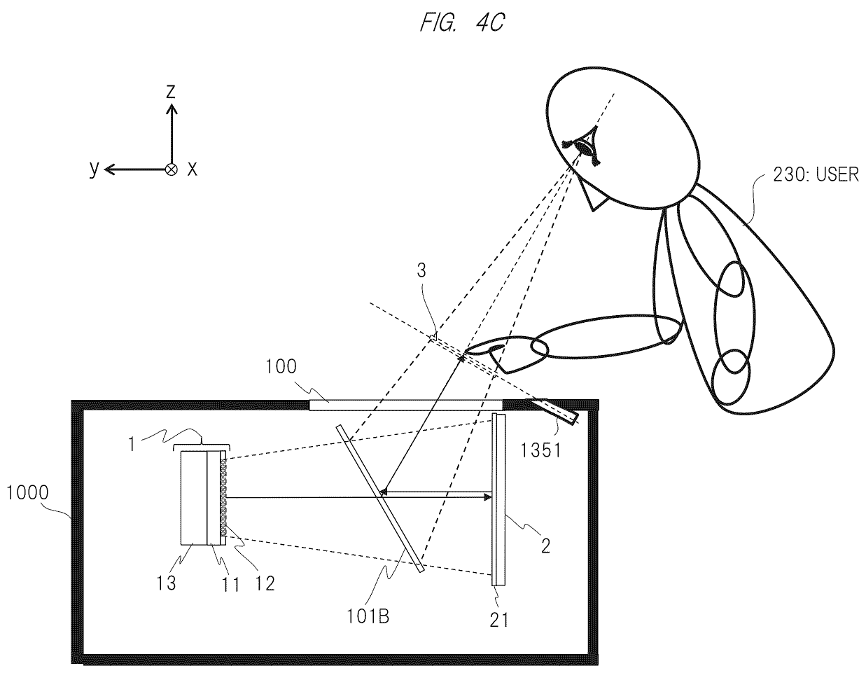

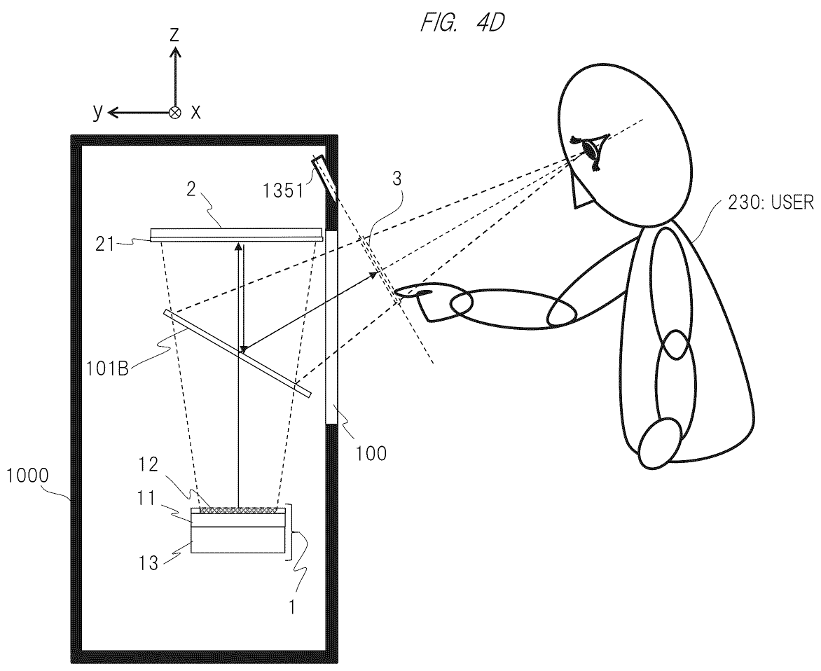

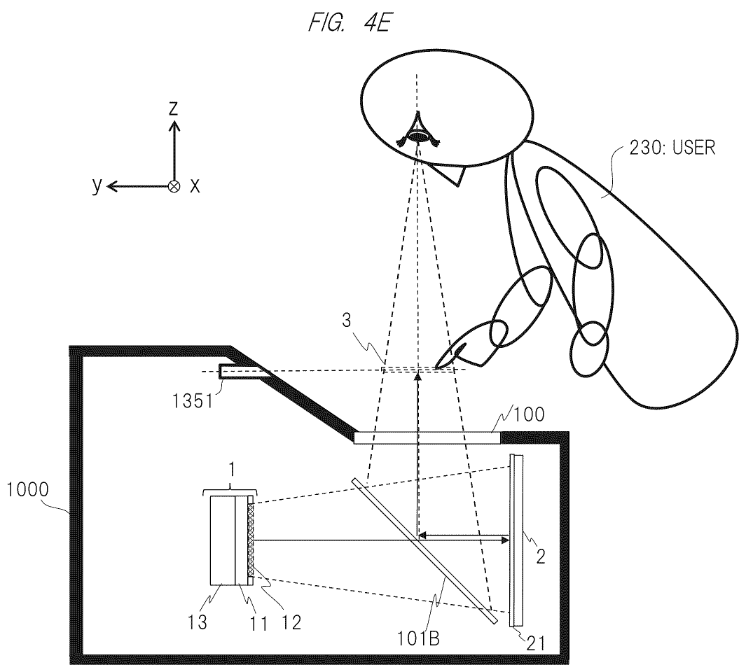

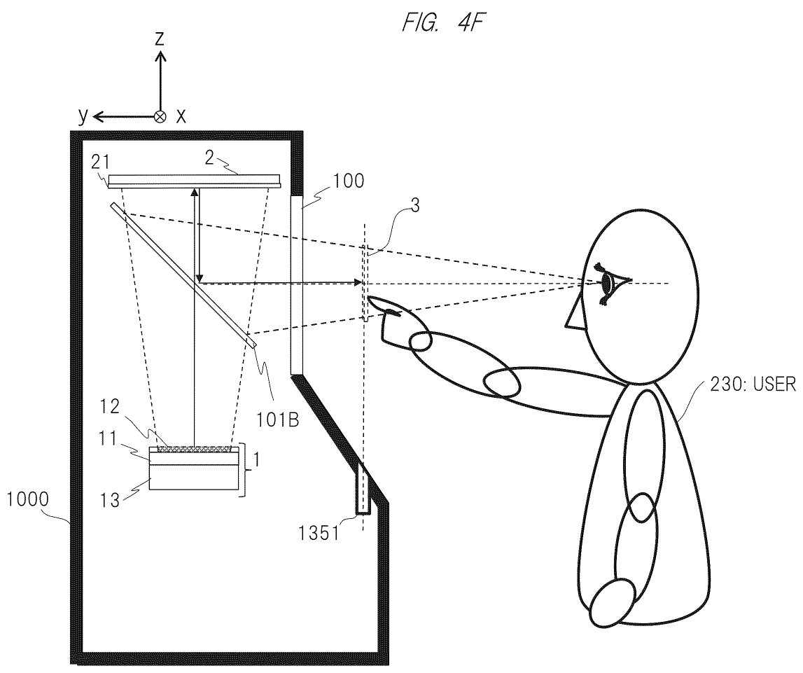

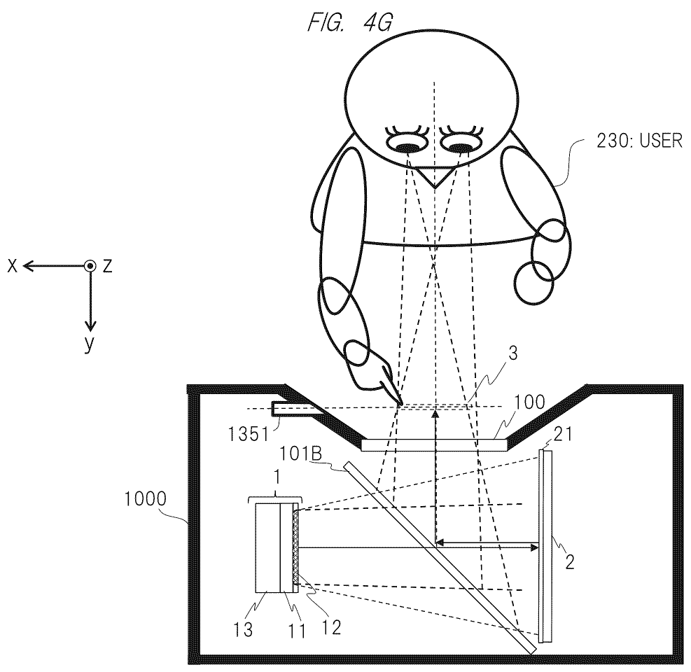

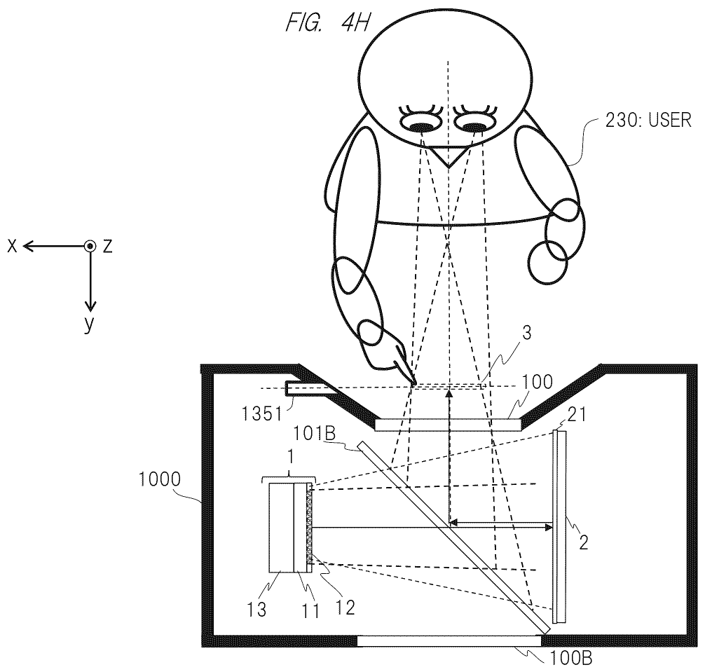

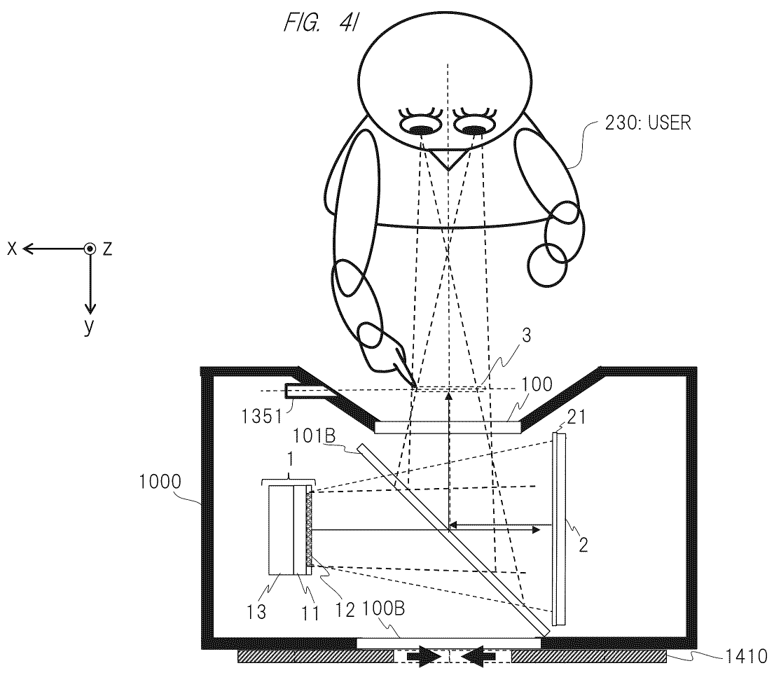

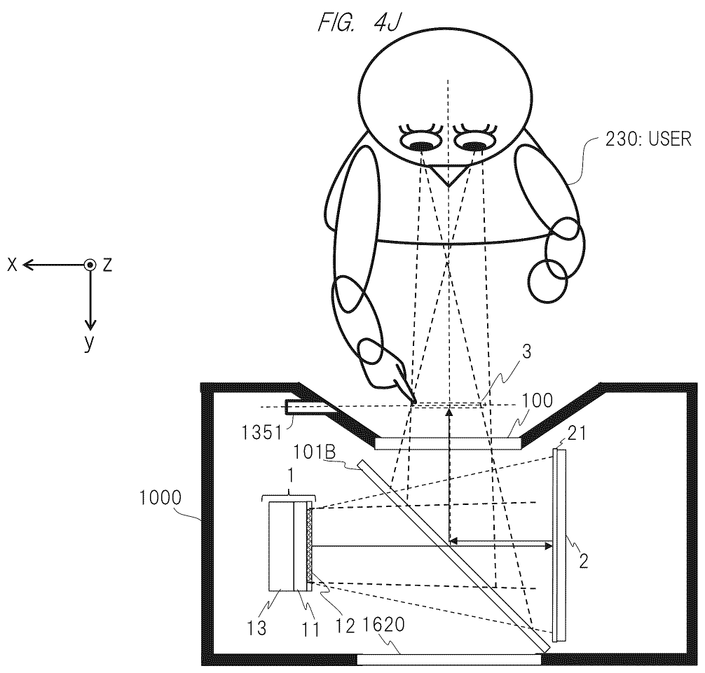

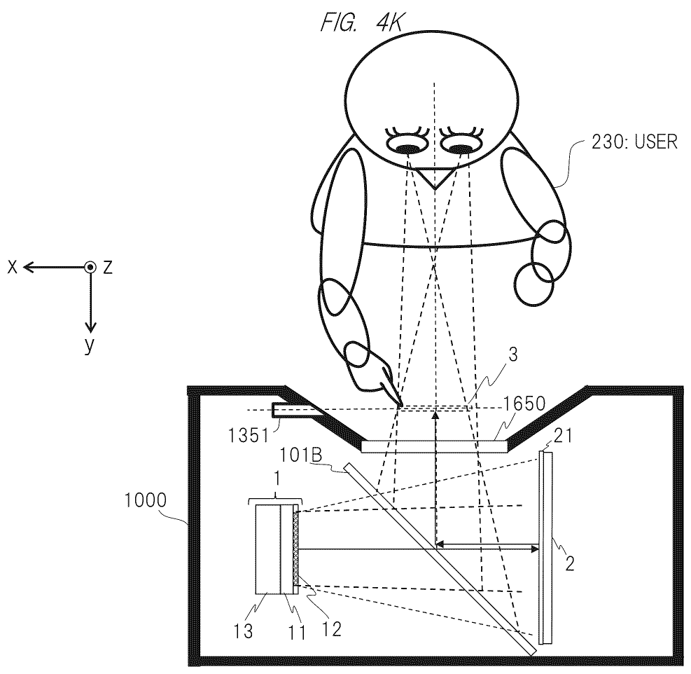

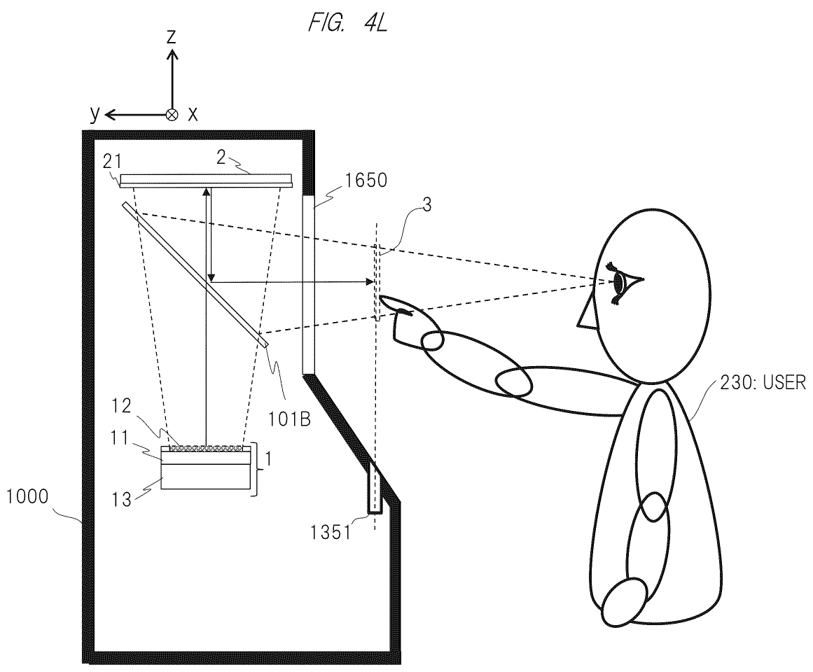

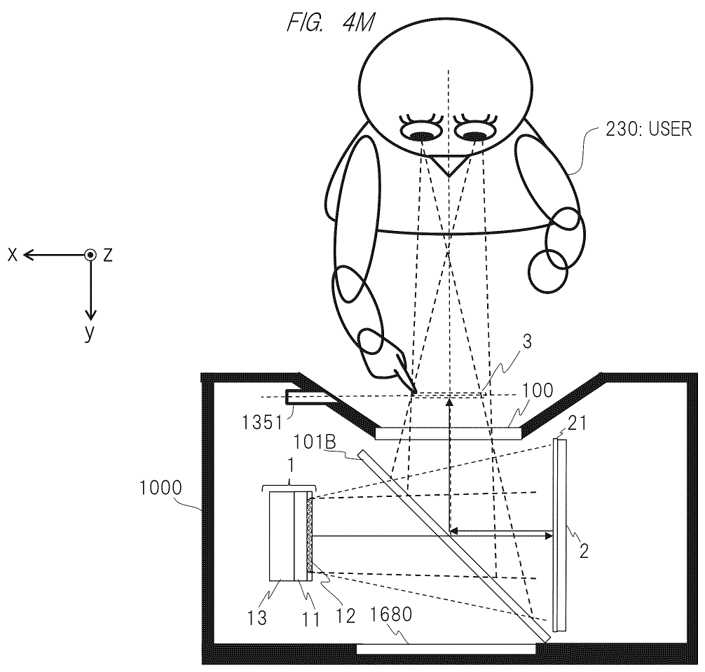

Next, the configuration example of the air floating video display apparatus will be described. As the layout of the components of the air floating video display apparatus according to the present embodiment, various layouts are possible depending on the usage form. Each layout in FIG. 4A to FIG. 4M will be described below. Note that, in any of the examples in FIG. 4A to FIG. 4M, a thick line surrounding the air floating video display apparatus 1000 indicates an example of the housing structure of the air floating video display apparatus 1000.

FIG. 4A is a diagram illustrating an example of the configuration of the air floating video display apparatus. The air floating video display apparatus 1000 illustrated in FIG. 4A is mounted with an optical system corresponding to the optical system illustrated in FIG. 2A. The air floating video display apparatus 1000 illustrated in FIG. 4A is installed horizontally such that the surface on the side where the air floating video 3 is formed faces upward. Namely, in FIG. 4A, the air floating video display apparatus 1000 has the transparent member 100 placed on an upper surface of the apparatus. The air floating video 3 is formed above the surface of the transparent member 100 of the air floating video display apparatus 1000. The light of the air floating video 3 travels obliquely upward. When the aerial operation detection sensor 1351 is provided as illustrated in the drawing, it is possible to detect the operation on the air floating video 3 by the finger of the user 230. Note that the x direction is the left-right direction when viewed from the user, the y direction is the front-rear direction (depth direction) when viewed from the user, and the z direction is the up-down direction (vertical direction). Hereinafter, since the definitions of the x direction, y direction, and z direction are the same in each drawing of FIG. 4A to FIG. 4M, repetitive description will be omitted.

FIG. 4B is a diagram illustrating an example of the configuration of the air floating video display apparatus. The air floating video display apparatus 1000 illustrated in FIG. 4B is mounted with an optical system corresponding to the optical system illustrated in FIG. 2A. The air floating video display apparatus 1000 illustrated in FIG. 4B is installed vertically such that the surface on the side where the air floating video 3 is formed is located on the front side of the air floating video display apparatus 1000 (faces the user 230). Namely, in FIG. 4B, the air floating video display apparatus 1000 has the transparent member 100 placed on the front side of the apparatus (on the side of the user 230). The air floating video 3 is formed on the side of the user 230 with respect to the surface of the transparent member 100 of the air floating video display apparatus 1000. The light of the air floating video 3 travels obliquely upward. When the aerial operation detection sensor 1351 is provided as illustrated in the drawing, it is possible to detect the operation on the air floating video 3 by the finger of the user 230. Here, as illustrated in FIG. 4B, the aerial operation detection sensor 1351 can utilize the reflection of the sensing light by the nail of the user for touch detection by sensing the finger of the user 230 from above. Since a nail generally has a higher reflectance than a pad of a finger, this configuration can improve the accuracy of touch detection.

FIG. 4C is a diagram illustrating an example of the configuration of the air floating video display apparatus. The air floating video display apparatus 1000 illustrated in FIG. 4C is mounted with an optical system corresponding to the optical system illustrated in FIG. 2B. The air floating video display apparatus 1000 illustrated in FIG. 4C is installed horizontally such that the surface on the side where the air floating video 3 is formed faces upward. Namely, in FIG. 4C, the air floating video display apparatus 1000 has the transparent member 100 placed on the upper surface of the apparatus. The air floating video 3 is formed above the surface of the transparent member 100 of the air floating video display apparatus 1000. The light of the air floating video 3 travels obliquely upward. When the aerial operation detection sensor 1351 is provided as illustrated in the drawing, it is possible to detect the operation on the air floating video 3 by the finger of the user 230.

FIG. 4D is a diagram illustrating an example of the configuration of the air floating video display apparatus. The air floating video display apparatus 1000 illustrated in FIG. 4D is mounted with an optical system corresponding to the optical system illustrated in FIG. 2B. The air floating video display apparatus 1000 illustrated in FIG. 4D is installed vertically such that the surface on the side where the air floating video 3 is formed is located on the front side of the air floating video display apparatus 1000 (faces the user 230). Namely, in FIG. 4D, the air floating video display apparatus 1000 has the transparent member 100 placed on the front side of the apparatus (on the side of the user 230). The air floating video 3 is formed on the side of the user 230 with respect to the surface of the transparent member 100 of the air floating video display apparatus 1000. The light of the air floating video 3 travels obliquely upward. When the aerial operation detection sensor 1351 is provided as illustrated in the drawing, it is possible to detect the operation on the air floating video 3 by the finger of the user 230. Here, as illustrated in FIG. 4D, the aerial operation detection sensor 1351 can utilize the reflection of the sensing light by the nail of the user for touch detection by sensing the finger of the user 230 from above. Since a nail generally has a higher reflectance than a pad of a finger, this configuration can improve the accuracy of touch detection.

FIG. 4E is a diagram illustrating an example of the configuration of the air floating video display apparatus. The air floating video display apparatus 1000 illustrated in FIG. 4E is mounted with an optical system corresponding to the optical system illustrated in FIG. 2C. The air floating video display apparatus 1000 illustrated in FIG. 4E is installed horizontally such that the surface on the side where the air floating video 3 is formed faces upward. Namely, in FIG. 4E, the air floating video display apparatus 1000 has the transparent member 100 placed on the upper surface of the apparatus. The air floating video 3 is formed above the surface of the transparent member 100 of the air floating video display apparatus 1000. The light of the air floating video 3 travels directly upward. When the aerial operation detection sensor 1351 is provided as illustrated in the drawing, it is possible to detect the operation on the air floating video 3 by the finger of the user 230.

FIG. 4F is a diagram illustrating an example of the configuration of the air floating video display apparatus. The air floating video display apparatus 1000 illustrated in FIG. 4F is mounted with an optical system corresponding to the optical system illustrated in FIG. 2C. The air floating video display apparatus 1000 illustrated in FIG. 4F is installed vertically such that the surface on the side where the air floating video 3 is formed is located on the front side of the air floating video display apparatus 1000 (faces the user 230). Namely, in FIG. 4F, the air floating video display apparatus 1000 has the transparent member 100 placed on the front side of the apparatus (on the side of the user 230). The air floating video 3 is formed on the side of the user 230 with respect to the surface of the transparent member 100 of the air floating video display apparatus 1000. The light of the air floating video 3 travels toward the user. When the aerial operation detection sensor 1351 is provided as illustrated in the drawing, it is possible to detect the operation on the air floating video 3 by the finger of the user 230.

FIG. 4G is a diagram illustrating an example of the configuration of the air floating video display apparatus. The air floating video display apparatus 1000 illustrated in FIG. 4G is mounted with an optical system corresponding to the optical system illustrated in FIG. 2C. In the optical system of each air floating video display apparatus illustrated in FIG. 4A to FIG. 4F, the central optical path of the video light emitted from the display apparatus 1 is on the y-z plane. Namely, in the optical system of each air floating video display apparatus illustrated in FIG. 4A to FIG. 4F, the video light travels in the front-rear direction and the up-down direction when viewed from the user. On the other hand, in the optical system of the air floating video display apparatus illustrated in FIG. 4G, the central optical path of the video light emitted from the display apparatus 1 is on the x-y plane. Namely, in the optical system of the air floating video display apparatus illustrated in FIG. 4G, video light travels in the left-right direction and front-rear direction when viewed from the user. The air floating video display apparatus 1000 illustrated in FIG. 4G is installed such that the surface on the side where the air floating video 3 is formed is located on the front side of the apparatus (faces the user 230). Namely, in FIG. 4G, the air floating video display apparatus 1000 has the transparent member 100 placed on the front side of the apparatus (on the side of the user 230). The air floating video 3 is formed on the side of the user 230 with respect to the surface of the transparent member 100 of the air floating video display apparatus 1000. The light of the air floating video 3 travels toward the user. When the aerial operation detection sensor 1351 is provided as illustrated in the drawing, it is possible to detect the operation on the air floating video 3 by the finger of the user 230.

FIG. 4H is a diagram illustrating an example of the configuration of the air floating video display apparatus. The air floating video display apparatus 1000 in FIG. 4H is different from the air floating video display apparatus 1000 in FIG. 4G in that a window having a transparent plate 100B such as glass or plastic is provided on the rear side of the apparatus (on the opposite side of the position where the user 230 visually recognizes the air floating video 3, that is, on the opposite side of the traveling direction of the video light of the air floating video 3 toward the user 230). Since the other configuration is the same as that of the air floating video display apparatus in FIG. 4G, the repetitive description will be omitted. The air floating video display apparatus 1000 in FIG. 4H includes a window having the transparent plate 100B at a position on the opposite side of the traveling direction of the video light of the air floating video 3 with respect to the air floating video 3. Therefore, when the user 230 visually recognizes the air floating video 3, the user 230 can recognize the scenery behind the air floating video display apparatus 1000 as the background of the air floating video 3. Accordingly, the user 230 can perceive the air floating video 3 as if it is floating in the air in front of the scenery behind the air floating video display apparatus 1000. In this way, it is possible to further emphasize the sense of floating in the air of the air floating video 3.

Note that, depending on the polarization distribution of the video light output from the display apparatus 1 and the performance of the polarization separator 101B, there is a possibility that a part of the video light output from the display apparatus 1 is reflected by the polarization separator 101B and travels toward the transparent plate 100B. Depending on the coating property of the surface of the transparent plate 100B, the light may be reflected again on the surface of the transparent plate 100B and visually recognized by the user as stray light. Therefore, in order to prevent the stray light, the configuration in which the transparent plate 100B is not provided in the window on the rear side of the air floating video display apparatus 1000 is also possible.

FIG. 4I is a diagram illustrating an example of the configuration of the air floating video display apparatus. The air floating video display apparatus 1000 in FIG. 4I is different from the air floating video display apparatus 1000 in FIG. 4H in that an opening/closing door 1410 for blocking light is provided on the window of the transparent plate 100B provided on the rear side of the apparatus (on the opposite side of the position where the user 230 visually recognizes the air floating video 3). Since the other configuration is the same as that of the air floating video display apparatus in FIG. 4H, the repetitive description will be omitted. The opening/closing door 1410 of the air floating video display apparatus 1000 in FIG. 4I includes, for example, a light-blocking plate and a mechanism for moving (sliding), rotating, or attaching/detaching the light-blocking plate, so that the state of the window (rear-side window) of the transparent plate 100B located on the rear side of the air floating video display apparatus 1000 can be switched between an open state and a light-blocking state. The movement (sliding) or rotation of the light-blocking plate of the opening/closing door 1410 may be electrically driven by a motor (not illustrated). The motor may be controlled by the controller 1110 in FIG. 3. Note that, in the example in FIG. 4I, the case in which the light-blocking plate of the opening/closing door 1410 is composed of two plate members is disclosed. On the other hand, the light-blocking plate of the opening/closing door 1410 may be composed of one plate member.

For example, when the scenery seen behind the window of the transparent plate 100B of the air floating video display apparatus 1000 is outdoors, the brightness of sunlight varies depending on the weather. If the sunlight outside is strong, the background of the air floating video 3 may become too bright, and the visibility of the air floating video 3 for the user 230 may be lowered. In such a case, if the rear-side window can be brought into the light-blocking state by moving (sliding), rotating, or attaching the light-blocking plate of the opening/closing door 1410, the background of the air floating video 3 becomes dark and the visibility of the air floating video 3 can be increased relatively.

The blocking action by the light-blocking plate of the opening/closing door 1410 may be performed manually by the hand of the user 230. Alternatively, the blocking action by the light-blocking plate of the opening/closing door 1410 may be performed by a motor (not illustrated) under the control of the controller 1110 in response to the operation input via the operation input unit 1107 in FIG. 3.

Note that it is also possible to measure the brightness of the space beyond the rear-side window by providing an illuminance sensor on the back side of the air floating video display apparatus 1000 (the side opposite to the user 230), for example, near the rear-side window. In this case, the opening/closing action of the light-blocking plate of the opening/closing door 1410 may be performed by a motor (not illustrated) under the control of the controller 1110 in FIG. 3 based on the detection result of the illuminance sensor. By controlling the opening/closing action of the light-blocking plate of the opening/closing door 1410 in this manner, the visibility of the air floating video 3 can be favorably maintained even if the user 230 does not manually open and close the light-blocking plate of the opening/closing door 1410.

Further, the light-blocking plate of the opening/closing door 1410 may be configured to be manually attachable/detachable. Depending on the purpose of use and installation environment of the air floating video display apparatus 1000, the user can select whether the rear-side window is brought into an open state or a light-blocking state. If it is planned to use the air floating video display apparatus 1000 while keeping the rear-side window in the light-shieling state for a long period of time, the attachable/detachable light-blocking plate may be fixed in the light-blocking state. Meanwhile, if it is planned to use the air floating video display apparatus 1000 while keeping the rear-side window in the open state for a long period of time, the attachable/detachable light-blocking plate may be detached. The light-blocking plate may be attached and detached using screws, a hook structure, or a fitting structure.

Note that, even in the example of the air floating video display apparatus 1000 in FIG. 4I, depending on the polarization distribution of the video light output from the display apparatus 1 and the performance of the polarization separator 101B, there is a possibility that a part of the video light output from the display apparatus 1 is reflected by the polarization separator 101B and travels toward the transparent plate 100B. Depending on the coating property of the surface of the transparent plate 100B, the light may be reflected again on the surface of the transparent plate 100B and visually recognized by the user as stray light. Therefore, in order to prevent the stray light, the configuration in which the transparent plate 100B is not provided in the window on the rear side of the air floating video display apparatus 1000 is also possible. The above-described opening/closing door 1410 may be provided on the window that is not provided with the transparent plate 100B. In order to prevent the stray light, it is desirable that the inner surface of the light-blocking plate 1410 inside the housing has a coating or a material with low light reflectance.

FIG. 4J is a diagram illustrating an example of the configuration of the air floating video display apparatus. The air floating video display apparatus 1000 in FIG. 4J is different from the air floating video display apparatus in FIG. 4H in that an electronically-controlled transmittance variable unit 1620 is arranged on the rear-side window instead of arranging the transparent plate 100B made of glass or plastic. Since the other configuration is the same as that of the air floating video display apparatus in FIG. 4H, the repetitive description will be omitted. An example of the electronically-controlled transmittance variable unit 1620 is a liquid crystal shutter or the like. Namely, the liquid crystal shutter can control the light transmittance by controlling the voltage applied to the liquid crystal element sandwiched between polarization plates. Therefore, by controlling the liquid crystal shutter to increase the transmittance, the scenery beyond the rear-side window can be seen through the air floating video 3 on the background. Meanwhile, by controlling the liquid crystal shutter to reduce the transmittance, the scenery beyond the rear-side window cannot be seen through the air floating video 3 on the background. Further, since the halftone control is possible in the liquid crystal shutter, it can be set to, for example, a state of transmittance of 50%. For example, the controller 1110 can control the transmittance of the electronically-controlled transmittance variable unit 1620 in response to the operation input via the operation input unit 1107 in FIG. 3. With this configuration, in such a case where it is desired to see the scenery beyond the rear-side window as the background of the air floating video 3, but the scenery beyond the rear-side window on the background is too bright and the visibility of the air floating video 3 is lowered, the visibility of the air floating video 3 can be adjusted by controlling the transmittance of the electronically-controlled transmittance variable unit 1620.

Note that it is also possible to measure the brightness of the space beyond the rear-side window by providing an illuminance sensor on the back side of the air floating video display apparatus 1000 (the side opposite to the user 230), for example, near the rear-side window. In this case, the controller 1110 in FIG. 3 can control the transmittance of the electronically-controlled transmittance variable unit 1620 based on the detection result of the illuminance sensor. In this way, since the transmittance of the electronically-controlled transmittance variable unit 1620 can be adjusted based on the brightness of the space beyond the rear-side window even if the user 230 does not perform the operation input via the operation input unit 1107 in FIG. 3, it is possible to favorably maintain the visibility of the air floating video 3.

Furthermore, in the above example, the case where a liquid crystal shutter is used as the electronically-controlled transmittance variable unit 1620 has been described. Alternatively, electronic paper may be used as another example of the electronically-controlled transmittance variable unit 1620. Even in the case where electronic paper is used, the same effect as that described above can be obtained. Moreover, power consumption required to maintain the halftone state is very small in the electronic paper. Therefore, it is possible to realize the air floating video display apparatus with lower power consumption as compared with the case where a liquid crystal shutter is adopted.

FIG. 4K is a diagram illustrating an example of the configuration of the air floating video display apparatus. The air floating video display apparatus 1000 in FIG. 4K is different from the air floating video display apparatus in FIG. 4G in that a transmissive self-luminous video display apparatus 1650 is provided instead of the transparent member 100. Since the other configuration is the same as that of the air floating video display apparatus in FIG. 4G, the repetitive description will be omitted.

In the air floating video display apparatus 1000 in FIG. 4K, after the video light flux passes through the display surface of the transmissive self-luminous video display apparatus 1650, the air floating video 3 is formed outside the air floating video display apparatus 1000. Namely, when a video is being displayed on the transmissive self-luminous video display apparatus 1650 which is a two-dimensional flat display, the air floating video 3 can be displayed as a projected video on the front side of the user with respect to the video on the transmissive self-luminous video display apparatus 1650. At this time, the user 230 can visually recognize two videos at different depth positions at the same time. The transmissive self-luminous video display apparatus 1650 can be configured using existing techniques of a transmissive organic EL panel disclosed in, for example, Japanese Unexamined Patent Application Publication No. 2014-216761. Although the transmissive self-luminous video display apparatus 1650 is not illustrated in FIG. 3, it can be configured as a component of the air floating video display apparatus 1000 in FIG. 3 so as to be connected to the other processing units such as the controller 1110.

Here, for example, if the performance that both the background and objects such as characters are displayed on the transmissive self-luminous video display apparatus 1650 and then the objects such as characters only are moved to the air floating video 3 on the front side is executed, it is possible to provide the user 230 with a more effective video experience with surprising effects.

Further, if the inside of the air floating video display apparatus 1000 is set to the light-blocking state, the background of the transmissive self-luminous video display apparatus 1650 becomes sufficiently dark. Therefore, in the case where no video is displayed on the display apparatus 1 or the light source of the display apparatus 1 is turned off and the video is displayed only on the transmissive self-luminous video display apparatus 1650, the transmissive self-luminous video display apparatus 1650 appears to the user 230 as if it is an ordinary two-dimensional flat display rather than a transmissive display (since the air floating video 3 in the embodiment of the present invention is displayed as a real optical image in a space without a screen, the position where the air floating video 3 is to be displayed becomes an empty space when the light source of the display apparatus 1 is turned off). Therefore, if the characters and objects are suddenly displayed in the air as the air floating video 3 when the video is being displayed using the transmissive self-luminous video display apparatus 1650 as a general two-dimensional flat display, it is possible to provide the user 230 with a more effective video experience with surprising effects.

Note that the darker the inside of the air floating video display apparatus 1000 becomes, the more the transmissive self-luminous video display apparatus 1650 appears like a two-dimensional flat display. Therefore, an absorptive polarization plate (not illustrated) that transmits the polarized wave of the video light reflected by the polarization separator 101B and absorbs the polarized wave whose phase is different by 90° from this polarized wave may be provided on the inner surface of the transmissive self-luminous video display apparatus 1650 inside the air floating video display apparatus 1000 (the incident surface of the video light reflected by the polarization separator 101B to the transmissive self-luminous video display apparatus 1650, that is, the surface of the transmissive self-luminous video display apparatus 1650 on the side opposite to the air floating video 3). In this way, although the influence on the video light that forms the air floating video 3 is not so great, the light that enters the interior of the air floating video display apparatus 1000 from the outside via the transmissive self-luminous video display apparatus 1650 can be significantly reduced, and the interior of the air floating video display apparatus 1000 can be favorably made darker.

FIG. 4L is a diagram illustrating an example of the configuration of the air floating video display apparatus. The air floating video display apparatus 1000 in FIG. 4L is a modification of the air floating video display apparatus in FIG. 4K. The arrangement direction of the configuration in the air floating video display apparatus 1000 is different from that of the air floating video display apparatus illustrated in FIG. 4K, and is similar to that of the air floating video display apparatus illustrated in FIG. 4F. Since the functions, operations, and the like of each configuration are the same as those of the air floating video display apparatus in FIG. 4K, the repetitive description will be omitted.

In the air floating video display apparatus in FIG. 4L as well, after the light flux of the video light passes through the transmissive self-luminous video display apparatus 1650, the air floating video 3 is formed on the side of the user 230 with respect to the transmissive self-luminous video display apparatus 1650.

In both the example of the air floating video display apparatus in FIG. 4K and the example of the air floating video display apparatus in FIG. 4L, the air floating video 3 is displayed to be overlapped in front of the video of the transmissive self-luminous video display apparatus 1650 when viewed from the user 230. Here, the position of the air floating video 3 and the position of the video of the transmissive self-luminous video display apparatus 1650 are designed to be different in the depth direction. Therefore, when the user moves his or her head (position of the viewpoint), the depth of the two videos can be recognized based on the parallax. Therefore, by displaying two videos with different depth positions, a three-dimensional video experience can be more suitably provided to the user with naked eyes without the need for stereoscopic glasses or the like.

FIG. 4M is a diagram illustrating an example of the configuration of the air floating video display apparatus. In the air floating video display apparatus 1000 in FIG. 4M, a second display apparatus 1680 is provided on the rear side when viewed from the user with respect to the polarization separator 101B of the air floating video display apparatus in FIG. 4G. Since the other configuration is the same as that of the air floating video display apparatus in FIG. 4G, the repetitive description will be omitted.

In the configuration example illustrated in FIG. 4M, the second display apparatus 1680 is provided on the rear side of the display position of the air floating video 3, and the video display surface is directed toward the air floating video 3. With this configuration, when viewed from the user 230, two videos such as the video of the second display apparatus 1680 and the air floating video 3 which are displayed at two different depth positions can be visually recognized to be overlapped with each other. Namely, it can be said that the second display apparatus 1680 is arranged so as to display the video in the direction toward the user 230 who visually recognizes the air floating video 3. Although not illustrated in FIG. 3, the second display apparatus 1680 can be configured as a component of the air floating video display apparatus 1000 in FIG. 3 so as to be connected to other processors such as the controller 1110.

Note that the video light from the second display apparatus 1680 of the air floating video display apparatus 1000 in FIG. 4M is visually recognized by the user 230 after passing through the polarization separator 101B. Therefore, in order for the video light of the second display apparatus 1680 to pass through the polarization separator 101B more suitably, the video light output from the second display apparatus 1680 is desirably the light of a polarized wave having a vibration direction capable of passing through the polarization separator 101B more suitably. Namely, it is desirably the light of a polarized wave having the same vibration direction as the polarized wave of the video light output from the display apparatus 1. For example, when the video light output from the display apparatus 1 is S-polarized light, it is desirable that the video light output from the second display apparatus 1680 is also S-polarized light. Also, when the video light output from the display apparatus 1 is P-polarized light, it is desirable that the video light output from the second display apparatus 1680 is also P-polarized light.

The example of the air floating video display apparatus in FIG. 4M also has the same effect as those of the example of the air floating video display apparatus in FIG. 4K and the example of the air floating video display apparatus in FIG. 4L in that the second video is displayed behind the air floating video 3. However, unlike the example of the air floating video display apparatus in FIG. 4K and the example of the air floating video display apparatus in FIG. 4L, the light flux of the video light for forming the air floating video 3 does not pass through the second display apparatus 1680 in the example of the air floating video display apparatus in FIG. 4M. Therefore, the second display apparatus 1680 does not need to be a transmissive self-luminous video display apparatus, and may be a liquid crystal display that is a two-dimensional flat display. The second display apparatus 1680 may also be an organic EL display. Therefore, in the example of the air floating video display apparatus in FIG. 4M, the air floating video display apparatus 1000 can be realized at a lower cost than those in the example of the air floating video display apparatus in FIG. 4K and the example of the air floating video display apparatus in FIG. 4L.

Here, depending on the polarization distribution of the video light output from the display apparatus 1 and the performance of the polarization separator 101B, there is a possibility that a part of the video light output from the display apparatus 1 is reflected by the polarization separator 101B and travels toward the second apparatus 1680. This light (part of video light) may be reflected again on the surface of the second display apparatus 1680 and visually recognized by the user as stray light.

Therefore, in order to prevent the stray light, an absorptive polarization plate may be provided on the surface of the second display apparatus 1680. In this case, as the absorptive polarization plate, an absorptive polarization plate that transmits the polarized wave of the video light output from the second display apparatus 1680 and absorbs the polarized wave whose phase is different by 90° from the polarized wave of the video light output from the second display apparatus 1680 can be provided. Note that, when the second display apparatus 1680 is a liquid crystal display, an absorptive polarization plate is present also on the video emission side inside the liquid crystal display. However, when a cover glass (cover glass on the video display side) is present on the emission surface of the absorptive polarization plate on the video output side inside the liquid crystal display, it is not possible to prevent the stray light generated by the reflection of the cover glass by the light from outside of the liquid crystal display. Therefore, it is necessary to separately provide the above-mentioned absorptive polarization plate on the surface of the cover glass.

Note that, when a video is being displayed on the second display apparatus 1680 which is a two-dimensional flat display, the air floating video 3 can be displayed as a video on the front side of the user with respect to the video on the second display apparatus 1680. At this time, the user 230 can visually recognize two videos at different depth positions at the same time. By displaying the character on the air floating video 3 and displaying the background on the second display apparatus 1680, it is possible to provide an effect as if the user 230 is stereoscopically viewing the space in which the character exists.

Also, if the performance that both the background and objects such as characters are displayed on the second display apparatus 1680 and then the objects such as characters only are moved to the air floating video 3 on the front side is executed, it is possible to provide the user 230 with a more effective video experience with surprising effects.

### <Display Apparatus>

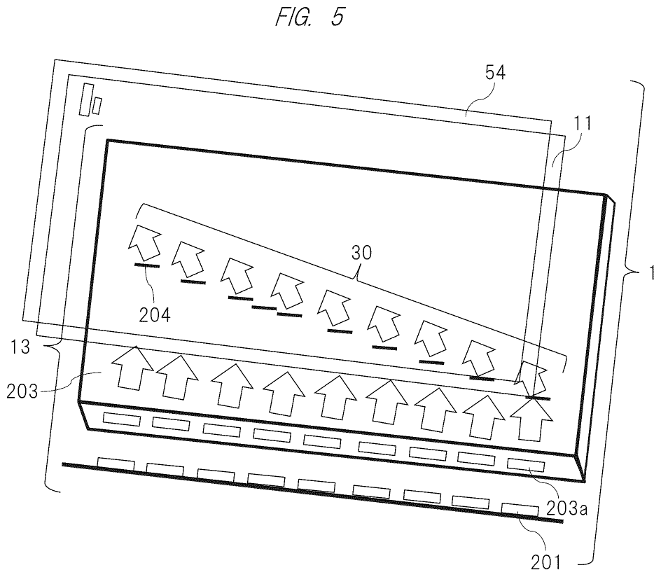

Next, the display apparatus 1 of the present embodiment will be described with reference to the drawings. The display apparatus 1 of the present embodiment includes a video display element 11 (liquid crystal display panel) and the light source apparatus 13 constituting a light source thereof, and FIG. 5 shows the light source apparatus 13 together with the liquid crystal display panel as a developed perspective view.

In the liquid crystal display panel (video display element 11), as indicated by arrows 30 in FIG. 5, an illumination light flux having narrow-angle diffusion characteristics, that is, characteristics similar to laser light with strong directivity (straightness) and a polarization plane aligned in one direction is received from the light source apparatus 13 as a backlight apparatus. The liquid crystal display panel (video display element 11) modulates the received illumination light flux in accordance with an input video signal. The modulated video light is reflected by the retroreflection plate 2 and transmitted through the transparent member 100, thereby forming an air floating image as a real image (see FIG. 1).

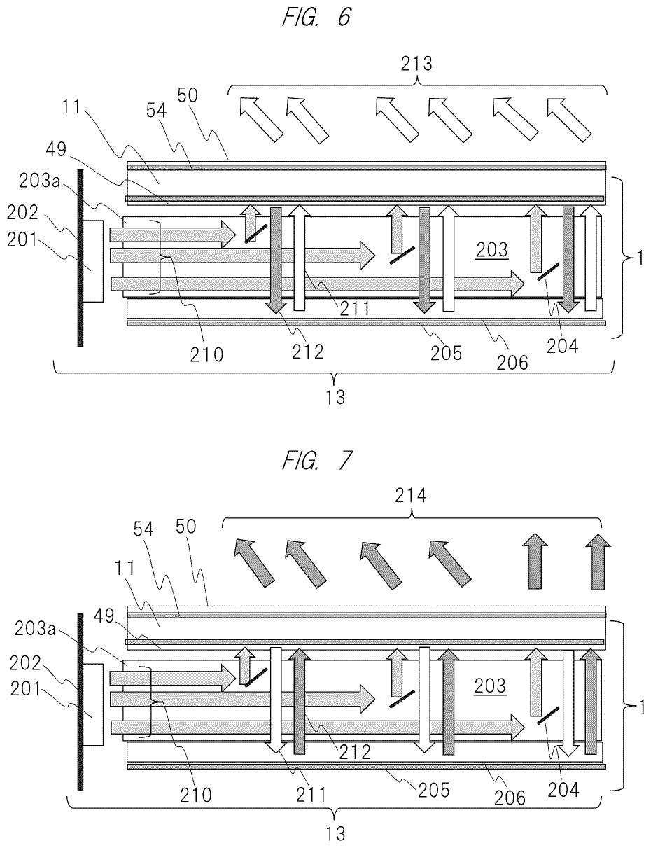

Further, in FIG. 5, the display apparatus 1 includes the liquid crystal display panel 11, a light direction conversion panel 54 configured to control the directional characteristics of the light flux emitted from the light source apparatus 13, and a narrow-angle diffusion plate as needed (not illustrated). Namely, polarization plates are provided on both surfaces of the liquid crystal display panel 11, and video light of a specific polarized wave is emitted at the light intensity modulated by the video signal (see the arrows 30 in FIG. 5). Thus, a desired video is projected as the light of a specific polarized wave having high directivity (straightness) toward the retroreflection plate 2 via the light direction conversion panel 54, reflected by the retroreflection plate 2, and then transmitted toward the eyes of an observer outside the store (space), thereby forming the air floating video 3. Note that a protective cover 50 (see FIG. 6 and FIG. 7) may be provided on the surface of the light direction conversion panel 54 described above.

### <Example of Display Apparatus (1)>

FIG. 6 shows an example of a specific configuration of the display apparatus 1. In FIG. 6, the liquid crystal display panel 11 and the light direction conversion panel 54 are arranged on the light source apparatus 13 in FIG. 5. The light source apparatus 13 is formed of, for example, plastic or the like on a case illustrated in FIG. 5, and is configured to accommodate the LED element 201 and a light guide 203 therein. Also, as illustrated in FIG. 5 and the like, in order to convert the divergent light from each LED element 201 into a substantially parallel light flux, the end surface of the light guide 203 is provided with a lens shape in which the cross-sectional area gradually increases toward the opposite surface with respect to the light receiving portion and which has a function of gradually reducing the divergence angle when making total reflection plural times during the propagation therein. The liquid crystal display panel 11 constituting the display apparatus 1 is attached to the upper surface of the display apparatus 1. Further, the LED (Light Emitting Diode) element 201 which is a semiconductor light source and an LED substrate 202 on which a control circuit thereof is mounted are attached to one side surface (an end surface on the left side in this example) of the case of the light source apparatus 13. A heat sink which is a member for cooling heat generated in the LED element and the control circuit may be attached to an outer surface of the LED substrate 202.

Also, to a frame (not illustrated) of the liquid crystal display panel attached to the upper surface of the case of the light source apparatus 13, the liquid crystal display panel 11 attached to the frame, an FPC (Flexible Printed Circuits) board (not illustrated) electrically connected to the liquid crystal display panel 11, and the like are attached. Namely, the liquid crystal display panel 11 which is a video display element generates a display video by modulating the intensity of transmitted light based on a control signal from a control circuit (video controller 1160 in FIG. 3) constituting an electronic device together with the LED element 201 which is a solid-state light source. At this time, since the generated video light has a narrow diffusion angle and only a specific polarization component, it is possible to obtain a novel and unconventional video display apparatus which is close to a surface-emitting laser video source driven by a video signal. Note that, at present, it is impossible to obtain a laser light flux having the same size as the image obtained by the above-described display apparatus 1 by using a laser apparatus for both technical and safety reasons. Therefore, in the present embodiment, for example, light close to the above-described surface-emitting laser video light is obtained from a light flux from a general light source including an LED element.

Subsequently, the configuration of the optical system accommodated in the case of the light source apparatus 13 will be described in detail with reference to FIG. 6 and FIG. 7.

Since FIG. 6 and FIG. 7 are cross-sectional views, only one of a plurality of LED elements 201 constituting the light source is illustrated, and the light from these elements is converted into substantially collimated light by the shape of a light-receiving end surface 203a of the light guide 203. Therefore, the light receiving portion on the end surface of the light guide and the LED element are attached while maintaining a predetermined positional relationship.

Note that each of the light guides 203 is formed of, for example, a translucent resin such as acrylic. Also, the LED light-receiving surface at one end of the light guide 203 has, for example, a conical convex outer peripheral surface obtained by rotating a parabolic cross section, the top thereof has a concave portion in which a convex portion (i.e., a convex lens surface) is formed at the central region, and the central region of the flat surface portion thereof has a convex lens surface protruding outward (or may be a concave lens surface recessed inward) (not illustrated). Note that the outer shape of the light receiving portion of the light guide to which the LED element 201 is attached is a paraboloid shape that forms a conical outer peripheral surface, and is set within a range of an angle at which light emitted from the LED element in the peripheral direction can be totally reflected inside the paraboloid, or has a reflection surface formed thereon.

On the other hand, each of the LED elements 201 is arranged at a predetermined position on the surface of the LED substrate 202 which is a circuit board for the LED elements. The LED substrate 202 is arranged and fixed to the LED collimator (the light-receiving end surface 203a) such that each of the LED elements 201 on the surface thereof is located at the central portion of the concave portion described above.

With such a configuration, the light emitted from the LED elements 201 can be extracted as substantially parallel light by the shape of the light-receiving end surface 203a of the light guide 203, and the utilization efficiency of the generated light can be improved.

As described above, the light source apparatus 13 is configured by attaching a light source unit, in which a plurality of LED elements 201 as light sources are arranged, to the light-receiving end surface 203a which is a light receiving portion provided on the end surface of the light guide 203, and the divergent light flux from the LED elements 201 is converted into substantially parallel light by the lens shape of the light-receiving end surface 203a on the end surface of the light guide, is guided through the inside of the light guide 203 (in the direction parallel to the drawing) as indicated by arrows, and is emitted toward the liquid crystal display panel 11 arranged substantially parallel to the light guide 203 (in the upward direction in the drawing) by a light flux direction converter 204. The uniformity of the light flux that enters the liquid crystal display panel 11 can be controlled by optimizing the distribution (density) of the light flux direction converter 204 by the shape inside the light guide or the shape of the surface of the light guide.

The above-described light flux direction converter 204 emits the light flux propagating through the inside of the light guide toward the liquid crystal display panel 11 (in the upward direction in the drawing) arranged substantially in parallel to the light guide 203 by the shape of the surface of the light guide or by providing a portion having a different refractive index inside the light guide. At this time, if the relative luminance ratio when comparing the luminance at the center of the screen with the luminance of the peripheral portion of the screen in a state in which the liquid crystal display panel 11 squarely faces the center of the screen and the viewpoint is placed at the same position as the diagonal dimension of the screen is 20% or more, there is no problem in practical use, and if the relative luminance ratio exceeds 30%, the characteristics will be even better.

Note that FIG. 6 is a cross-sectional layout drawing for describing the configuration and action of the light source of the present embodiment that performs polarization conversion in the light source apparatus 13 including the light guide 203 and the LED element 201 described above. In FIG. 6, the light source apparatus 13 is composed of, for example, the light guide 203 which is formed of plastic or the like and is provided with the light flux direction converter 204 on its surface or inside, the LED element 201 as a light source, a reflection sheet 205, a retardation plate 206, and a lenticular lens, and the liquid crystal display panel 11 including polarization plates on its light source light incident surface and video light emission surface is attached to the upper surface of the light source apparatus 13.

Also, a film-shaped or sheet-shaped reflective polarization plate 49 is provided on the light source light incident surface (lower surface in the drawing) of the liquid crystal display panel 11 corresponding to the light source apparatus 13, by which one polarized wave (e.g., a P-wave) 212 of the natural light flux 210 emitted from the LED element 201 is selectively reflected. The reflected light is reflected again by the reflection sheet 205 provided on one surface (lower side in the drawing) of the light guide 203, and is directed toward the liquid crystal display panel 11. Then, a retardation plate (λ/4 plate) is provided between the reflection sheet 205 and the light guide 203 or between the light guide 203 and the reflective polarization plate 49, and the light flux is reflected by the reflection sheet 205 to be made to pass through the retardation plate twice, so that the reflected light flux is converted from the P-polarized light to the S-polarized light and the utilization efficiency of the light source light as video light can be improved. The video light flux (arrows 213 in FIG. 6) whose light intensity is modulated by the video signal in the liquid crystal display panel 11 enters the retroreflection plate 2. An air floating image which is a real image can be obtained after the reflection on the retroreflection plate 2.

As with FIG. 6, FIG. 7 is a cross-sectional layout drawing for describing the configuration and action of the light source of the present embodiment that performs polarization conversion in the light source apparatus 13 including the light guide 203 and the LED element 201. The light source apparatus 13 is similarly composed of, for example, the light guide 203 which is formed of plastic or the like and is provided with the light flux direction converter 204 on its surface or inside, the LED element 201 as a light source, the reflection sheet 205, the retardation plate 206, and the lenticular lens. The liquid crystal display panel 11 including polarization plates on its light source light incident surface and video light emission surface is attached as the video display element to the upper surface of the light source apparatus 13.

Also, the film-shaped or sheet-shaped reflective polarization plate 49 is provided on the light source light incident surface (lower surface in the drawing) of the liquid crystal display panel 11 corresponding to the light source apparatus 13, by which one polarized wave (e.g., a S-wave) 211 of the natural light flux 210 emitted from the LED element 201 is selectively reflected. Namely, in the example in FIG. 7, the selective reflection property of the reflective polarization plate 49 is different from that in FIG. 6. The reflected light is reflected by the reflection sheet 205 provided on one surface (lower side in the drawing) of the light guide 203, and is directed toward the liquid crystal display panel 11. Then, a retardation plate (λ/4 plate) is provided between the reflection sheet 205 and the light guide 203 or between the light guide 203 and the reflective polarization plate 49, and the light flux is reflected by the reflection sheet 205 to be made to pass through the retardation plate twice, so that the reflected light flux is converted from the S-polarized light to the P-polarized light and the utilization efficiency of the light source light as video light can be improved. The video light flux (arrows 214 in FIG. 7) whose light intensity is modulated by the video signal in the liquid crystal display panel 11 enters the retroreflection plate 2. An air floating image which is a real image can be obtained after the reflection on the retroreflection plate 2.

In the light source apparatuses illustrated in FIG. 6 and FIG. 7, in addition to the action of the polarization plate provided on the light incident surface of the corresponding liquid crystal display panel 11, the polarization component on one side is reflected by the reflective polarization plate, and thus the contrast ratio theoretically obtained is the product of the reciprocal of the cross transmittance of the reflective polarization plate and the reciprocal of the cross transmittance obtained by the two polarization plates attached to the liquid crystal display panel. Therefore, high contrast performance can be obtained. In practice, it has been experimentally confirmed that the contrast performance of the display image is improved by 10 times or more. As a result, a high-quality video comparable to the video of a self-luminous organic EL can be obtained.

### <Example of Display Apparatus (2)>

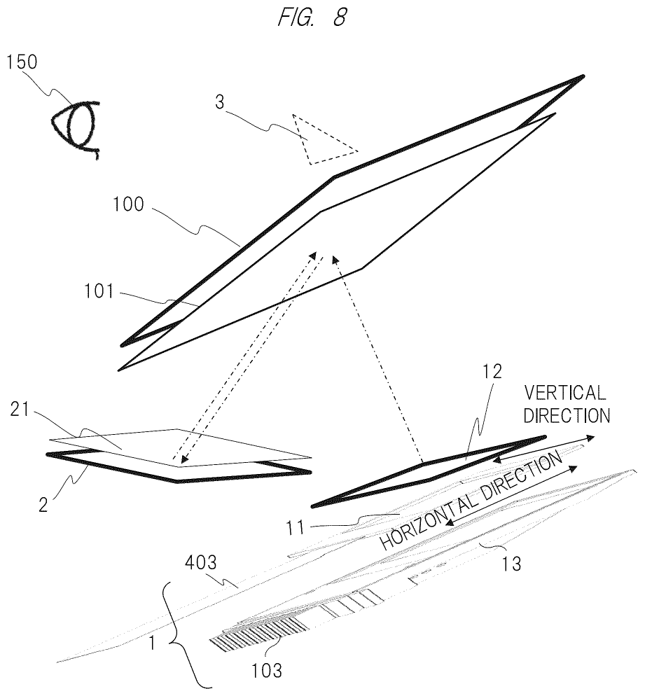

FIG. 8 shows another example of a specific configuration of the display apparatus 1. The light source apparatus 13 is configured by accommodating an LED, a collimator, a synthetic diffusion block, a light guide, and the like in a case made of, for example, plastic, and the liquid crystal display panel 11 is attached to the upper surface thereof. Further, LED (Light Emitting Diode) elements 14a and 14b which are semiconductor light sources and an LED substrate on which a control circuit thereof is mounted are attached to one side surface of the case of the light source apparatus 13, and a heat sink 103 which is a member for cooling the heat generated in the LED elements and the control circuit is attached to an outer surface of the LED substrate.

Also, to a frame of the liquid crystal display panel attached to the upper surface of the case, the liquid crystal display panel 11 attached to the frame, an FPC (Flexible Printed Circuits) board 403 electrically connected to the liquid crystal display panel 11, and the like are attached. Namely, the liquid crystal display panel 11 which is a liquid crystal display element generates a display video by modulating the intensity of transmitted light based on a control signal from a control circuit (not illustrated here) constituting an electronic device together with the LED elements 14a and 14b which are solid-state light sources.

### <Example of Display Apparatus (3)>

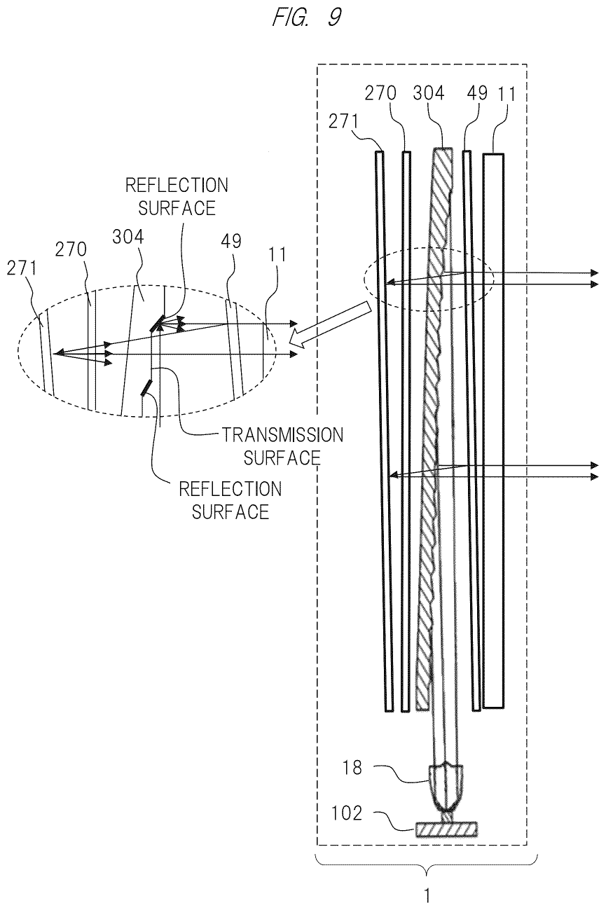

Next, another example of the specific configuration of the display apparatus 1 (example of display apparatus (3)) will be described with reference to FIG. 9. The light source apparatus of the display apparatus 1 converts a divergent light flux of the light from the LED (in which P-polarized light and S-polarized light are mixed) into a substantially parallel light flux by a collimator 18, and the converted light flux is reflected by the reflection surface of the reflective light guide 304 toward the liquid crystal display panel 11. Such reflected light enters the reflective polarization plate 49 arranged between the liquid crystal display panel 11 and the reflective light guide 304. The reflective polarization plate 49 transmits the light of a specific polarized wave (for example, P-polarized light) and allows the transmitted polarized light to enter the liquid crystal display panel 11. Here, the polarized wave (for example, S-polarized wave) other than the specific polarized wave is reflected by the reflective polarization plate 49 and directed toward the reflective light guide 304 again.

The reflective polarization plate 49 is installed to be inclined with respect to the liquid crystal display panel 11 so as not to be perpendicular to the principal light ray of the light from the reflection surface of the reflective light guide 304. Then, the principal light ray of the light reflected by the reflective polarization plate 49 enters the transmission surface of the reflective light guide 304. The light that has entered the transmission surface of the reflective e light guide 304 is transmitted through the back surface of the reflective light guide 304, is transmitted through a λ/4 plate 270 as a retardation plate, and is reflected by a reflection plate 271. The light reflected by the reflection plate 271 is transmitted through the λ/4 plate 270 again and is transmitted through the transmission surface of the reflective light guide 304. The light transmitted through the transmission surface of the reflective light guide 304 enters the reflective polarization plate 49 again.

At this time, since the light that enters the reflective polarization plate 49 again has passed through the λ/4 plate 270 twice, the polarization thereof is converted into a polarized wave (for example, P-polarized light) that can pass through the reflective polarization plate 49. Therefore, the light whose polarization has been converted passes through the reflective polarization plate 49 and enters the liquid crystal display panel 11. Regarding the polarization design related to polarization conversion, the polarization may be reversed from that in the above description (the S-polarized light and the P-polarized light may be reversed).

As a result, the light from the LED is aligned into a specific polarized wave (e.g., a P-polarized light) and enters the liquid crystal panel 11. Then, after the luminance is modulated in accordance with the video signal, the video is displayed on the panel surface. As with the above-described example, a plurality of LEDs constituting the light source are provided (however, only one LED is illustrated in FIG. 9 due to the vertical cross section), and these LEDs are attached at predetermined positions with respect to the collimators 18.

Note that each of the collimators 18 is formed of, for example, a translucent resin such as acrylic or glass. Further, the collimator 18 may have a conical convex outer peripheral surface obtained by rotating a parabolic cross section. Also, a concave portion in which a convex portion (i.e., a convex lens surface) is formed may be provided at the central portion of the top of the collimator 18 (on the side facing the LED substrate 102). In addition, a convex lens surface protruding outward (or may be a concave lens surface recessed inward) is provided at the central portion of the flat surface portion of the collimator 18 (on the opposite side of the top mentioned above). Note that the paraboloid that forms the conical outer peripheral surface of the collimator 18 is set within a range of an angle at which light emitted from the LED in the peripheral direction can be totally reflected inside the paraboloid, or has a reflection surface formed thereon.

Note that each of the LEDs is arranged at a predetermined position on the surface of the LED substrate 102 which is a circuit board for the LEDs. The LED substrate 102 is arranged and fixed to the collimator 18 such that each of the LEDs on the surface thereof is located at the central portion at the top of the conical convex portion (concave portion when there is the concave portion at the top).

With such a configuration, of the light emitted from the LED, in particular, the light emitted from the central portion thereof is condensed into parallel light by the convex lens surface forming the outer shape of the collimator 18. Also, the light emitted from the other portion toward the peripheral direction is reflected by the paraboloid forming the conical outer peripheral surface of the collimator 18, and is similarly condensed into parallel light. In other words, with the collimator 18 having a convex lens formed at the central portion thereof and a paraboloid formed in the peripheral portion thereof, it is possible to extract substantially all of the light generated by the LED as parallel light, and to improve the utilization efficiency of the generated light.

Furthermore, the light converted into substantially parallel light by the collimator 18 illustrated in FIG. 9 is reflected by the reflective light guide 304. The light of a specific polarized wave of such light is transmitted through the reflective polarization plate 49 by the action of the reflective polarization plate 49, and the light of the other polarized wave reflected by the action of the reflective polarization plate 49 is transmitted through the light guide 304 again. The light is reflected by the reflection plate 271 located at a position opposite to the liquid crystal display panel 11 with respect to the reflective light guide 304. At this time, the polarization of the light is converted by passing through the λ/4 plate 270, which is a retardation plate, twice. The light reflected by the reflection plate 271 is transmitted through the light guide 304 again and enters the reflective polarization plate 49 provided on the opposite surface. Since the incident light has been subjected to polarization conversion, it is transmitted through the reflective polarization plate 49 and enters the liquid crystal display panel 11 with the aligned polarization direction. As a result, all of the light from the light source can be used, and the utilization efficiency of light in geometrical optics is doubled. Further, the degree of polarization (extinction ratio) of the reflective polarization plate is also multiplied with the extinction ratio of the entire system, so that the contrast ratio of the overall display apparatus is significantly improved by using the light source apparatus of the present embodiment. Also, by adjusting the surface roughness of the reflection surface of the reflective light guide 304 and the surface roughness of the reflection plate 271, the reflection diffusion angle of light on each reflection surface can be adjusted. It is preferable that the surface roughness of the reflection surface of the reflective light guide 304 and the surface roughness of the reflection plate 271 are adjusted for each design such that the uniformity of the light entering the liquid crystal display panel 11 becomes more favorable.

Note that the λ/4 plate 270 which is the retardation plate in FIG. 9 does not necessarily have the phase difference of λ/4 with respect to the polarized light that has vertically entered the λ/4 plate 270. In the configuration of FIG. 9, any retardation plate may be used as long as it can change the phase by 90° (λ/2) when the polarized light passes through it twice. The thickness of the retardation plate may be adjusted in accordance with the incident angle distribution of polarized light.

### <Example of Display Apparatus (4)>

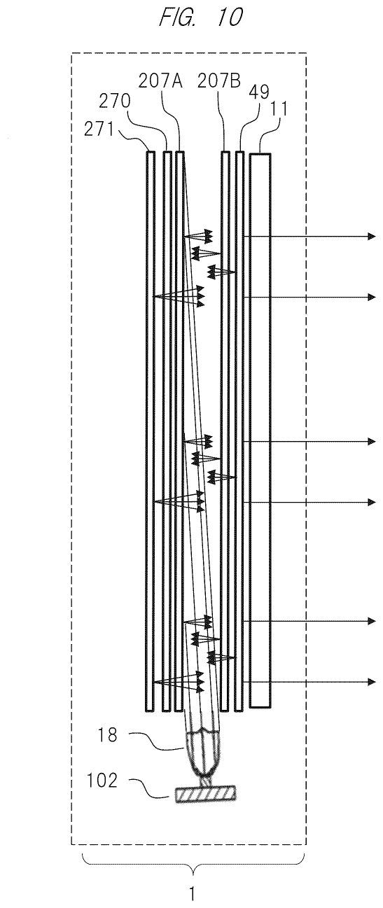

Further, another example (example of display apparatus (4)) of the configuration of the optical system of the light source apparatus or the like of the display apparatus will be described with reference to FIG. 10. This is a configuration example in which a diffusion sheet is used instead of the reflective light guide 304 in the light source apparatus in the example of display apparatus (3). Specifically, two optical sheets (optical sheet 207A and optical sheet 207B) for converting the diffusion characteristics in the vertical direction and the horizontal direction of the drawing are provided on the light emission side of the collimator 18, and the light from the collimator 18 is made to enter between the two optical sheets (diffusion sheets).

Note that this optical sheet may be composed of one sheet rather than two sheets. When composed of one sheet, the vertical and horizontal diffusion characteristics are adjusted by the fine shapes of the front surface and the back surface of the one optical sheet. Alternatively, a plurality of diffusion sheets may be used to share the function. Here, in the example in FIG. 10, it is preferable that the reflection diffusion characteristics by the front surface shapes and the back surface shapes of the optical sheet 207A and the optical sheet 207B are optimally designed with using the number of LEDs, the divergence angle from the LED substrate (optical element) 102, and optical specifications of the collimator 18 as design parameters such that the surface density of the light flux emitted from the liquid crystal display panel 11 is uniform. In other words, the diffusion characteristics are adjusted by the surface shapes of the plurality of diffusion sheets instead of the light guide.

In the example in FIG. 10, the polarization conversion is performed in the same manner as in the example of display apparatus (3) described above. Namely, in the example in FIG. 10, the reflective polarization plate 49 may be configured to have the property of reflecting the S-polarized light (and transmitting the P-polarized light). In that case, of the light emitted from the LED as a light source, the P-polarized light is transmitted and the transmitted light enters the liquid crystal display panel 11. Of the light emitted from the LED as a light source, the S-polarized light is reflected and the reflected: light is transmitted through the retardation plate 270 illustrated in FIG. 10. The light that has passed through the retardation plate 270 is reflected by the reflection plate 271. The light reflected by the reflection plate 271 is converted into the P-polarized light by passing through the retardation plate 270 again. The light that has been subjected to the polarization conversion is transmitted through the reflective polarization plate 49 and enters the liquid crystal display panel 11.

Note that the λ/4 plate 270 which is the retardation plate in FIG. 10 does not necessarily have the phase difference of λ/4 with respect to the polarized light that has vertically entered the λ/4 plate 270. In the configuration of FIG. 10, any retardation plate may be used as long as it can change the phase by 90° (λ/2) when the polarized light is transmitted through it twice. The thickness of the retardation plate may be adjusted in accordance with the incident angle distribution of polarized light. Also in FIG. 10, regarding the polarization design related to polarization conversion, the polarization may be reversed from that in the above description (the S-polarized light and the P-polarized light may be reversed).

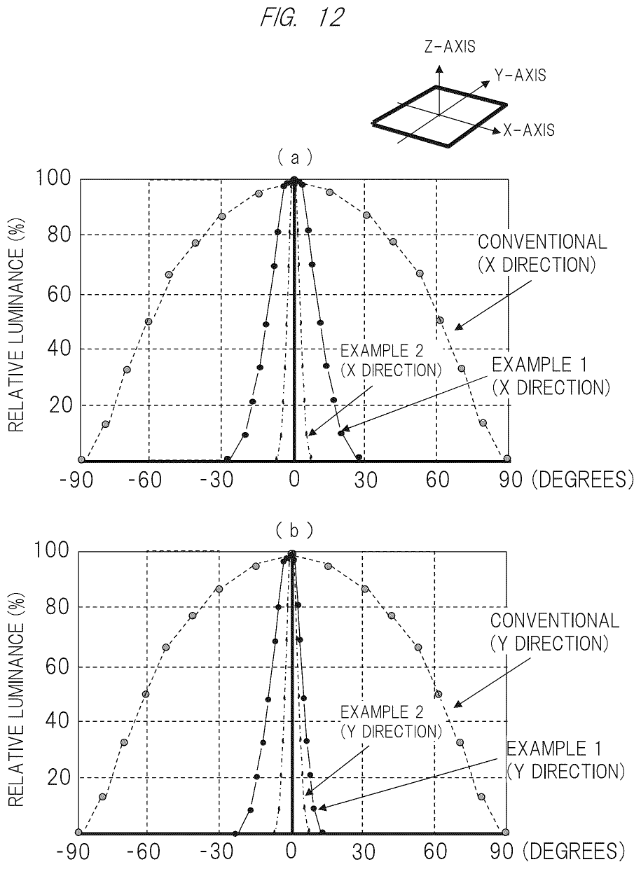

In an apparatus for use in a general TV set, the light emitted from the liquid crystal display panel 11 has similar diffusion characteristics in both the horizontal direction of the screen (indicated by the X axis in FIG. 12(a)) and the vertical direction of the screen (indicated by the Y axis in FIG. 12(b)). On the other hand, in the diffusion characteristics of the light flux emitted from the liquid crystal display panel of the present embodiment, for example, as illustrated in example 1 in FIG. 12, the viewing angle at which the luminance becomes 50% of that in front view (angle of 0 degrees) is 13 degrees, and this is ⅕ of 62 degrees in the apparatus for use in a general TV set. Similarly, the reflection angle of the reflective light guide, the area of the reflection surface, and the like are optimized such that the viewing angle in the vertical direction is made uneven in the upper and lower sides and the viewing angle on the upper side is suppressed to about ⅓ of the viewing angle on the lower side. As a result, the amount of video light toward the viewing direction is significantly improved as compared with the conventional liquid crystal TV, and the luminance is 50 times or more.

Further, in the viewing angle characteristics illustrated in example 2 in FIG. 12, the viewing angle at which the luminance becomes 50% of that in front view (angle of 0 degrees) is 5 degrees, and this is 1/12 of 62 degrees in the apparatus for use in a general TV set. Similarly, the reflection angle of the reflective light guide, the area of the reflection surface, and the like are optimized such that the viewing angle in the vertical direction is made even in the upper and lower sides and the viewing angle is suppressed to about 1/12 of the apparatus for use in a general TV set. As a result, the amount of video light toward the viewing direction is significantly improved as compared with the conventional liquid crystal TV, and the luminance is 100 times or more.

As described above, by setting the viewing angle to a narrow angle, the amount of light flux toward the viewing direction can be concentrated, so that the utilization efficiency of light is significantly improved. As a result, even if a liquid crystal display panel for use in a general TV set is used, it is possible to realize a significant improvement in luminance with the same power consumption by controlling the light diffusion characteristics of the light source apparatus, and to provide the video display apparatus suitable for the information display system for bright outdoor use.

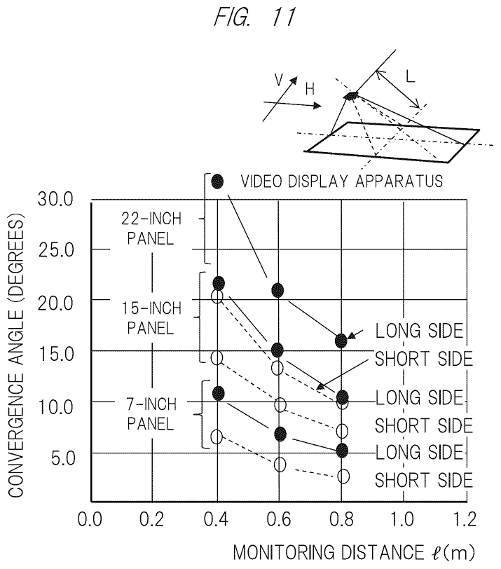

When using a large liquid crystal display panel, the overall brightness of the screen is improved by directing the light in the periphery of the screen inward, that is, toward the observer who is squarely facing the center of the screen. FIG. 11 shows the convergence angle of the long side and the short side of the panel when the distance L from the observer to the panel and the panel size (screen ratio 16:10) are used as parameters. In the case of monitoring the screen as a vertically long screen, the convergence angle may be set in accordance with the short side. For example, in the case in which a 22-inch panel is used vertically and the monitoring distance is 0.8 m, the video light from the four corners of the screen can be effectively directed toward the observer by setting the convergence angle to 10 degrees.

Similarly, in the case in which a 15-inch panel is used vertically and the monitoring distance is 0.8 m, the video light from the four corners of the screen can be effectively directed toward the observer by setting the convergence angle to 7 degrees. As described above, the overall brightness of the screen can be improved by adjusting the video light in the periphery of the screen so as to be directed to the observer located at the optimum position to monitor the center of the screen depending on the size of the liquid crystal display panel and whether the liquid crystal display panel is used vertically or horizontally.

As a basic configuration, as illustrated in FIG. 9, a light flux having narrow-angle directional characteristics is made to enter the liquid crystal display panel 11 by the light source apparatus, and the luminance is modulated in accordance with a video signal, whereby the air floating video obtained by reflecting the video information displayed on the screen of the liquid crystal display panel 11 by the retroreflection plate is displayed outdoors or indoors through the transparent member 100.

By using the display apparatus and the light source apparatus according to the embodiment of the present invention described above, it is possible to realize the air floating video display apparatus with high light utilization efficiency.

### <Examples of Air Floating Video Display Apparatus>

Next, examples of the air floating video display apparatus will be described. In the following examples, configurations capable of reducing the influence of the ghost image generated by the λ/4 plate 21 of the retroreflector are illustrated. The air floating video display apparatus in the example includes a video display apparatus including a liquid crystal display panel and a light source apparatus, a polarization separator that reflects the video light of a specific polarized wave from the video display apparatus and transmits the video light of the other polarized wave, a retroreflection module configured to retroreflect the reflected video light of the specific polarized wave from the polarization separator and convert it into a video light of the other polarized wave and including a λ/4 plate and a retroreflector, and a housing configured to hold the video display apparatus, the polarization separator, and the retroreflection module, and the video light of the other polarized wave from the retroreflection module is transmitted through the polarization separator to form an air floating video which is a real image at a predetermined position outside the housing. Furthermore, in the relationship between a first angle that the video display apparatus forms with respect to the polarization separator and a second angle that the retroreflection module forms with respect to the polarization separator, the second angle is different from the first angle. For example, the second angle is larger than the first angle, or the second angle is smaller than the first angle.

### <Problem of Ghost Image Generated by λ/4 Plate>

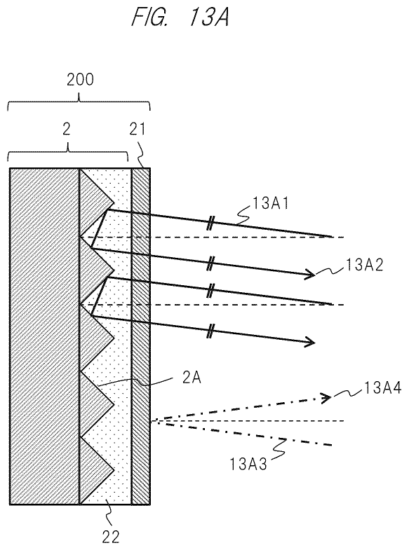

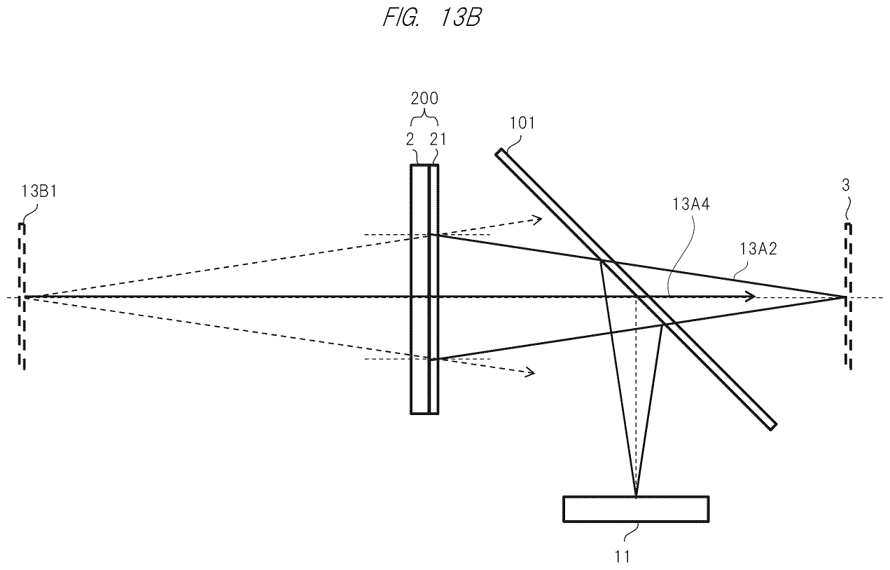

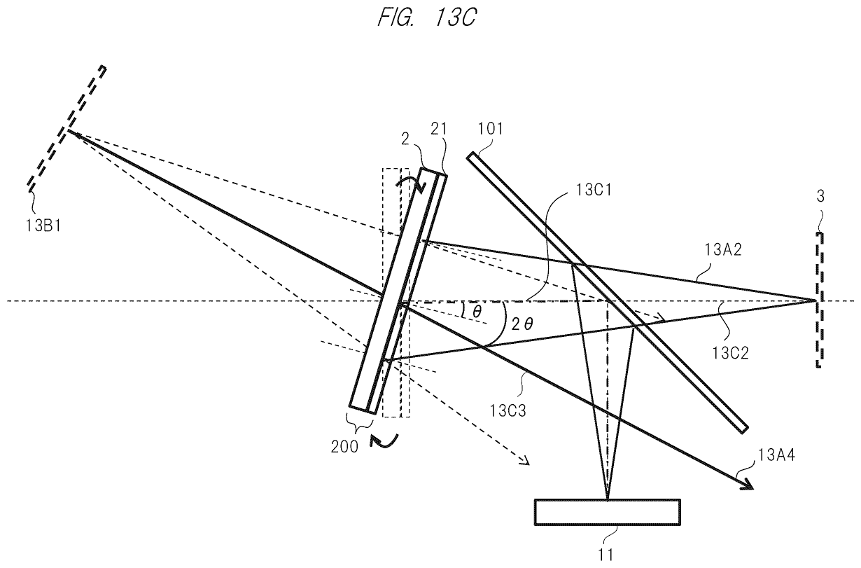

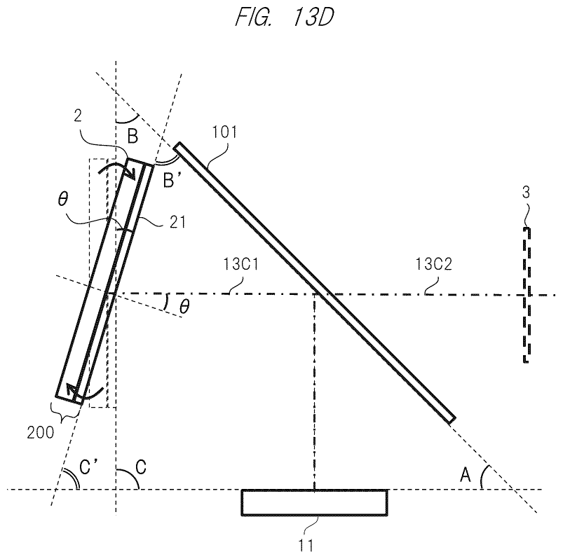

The problem of the ghost image generated by the λ/4 plate of the retroreflector will be described with reference to FIG. 13A and others. FIG. 13A is an explanatory diagram for the problem of the ghost image generated by the λ/4 plate of the retroreflector. FIG. 13A illustrates a schematic cross-sectional view (schematic diagram of a three-dimensional shape shown two-dimensionally) of a retroreflection module 200 having the retroreflector 2 and the λ/4 plate 21 provided on its retroreflection surface (front surface). A retroreflection surface 2A of the retroreflector 2 has, for example, a triangular surface shape as illustrated in the drawing. The λ/4 plate 21 is adhered and fixed to the retroreflection surface 2A of the retroreflector 2 via a sealing resin 22. An incident light 13A1 from the above-mentioned polarization separator 101 enters the retroreflection surface 2A and is emitted as retroreflected light 13A2 in the opposite direction by the surface shape of the retroreflection surface 2A.

Here, a part of the light entering the retroreflection surface 2A of the retroreflector 2 (incident light 13A3) is specularly reflected by the surface of the λ/4 plate 21 or the like, and is emitted as specularly reflected light, that is, irregular video light 13A4. The specularly reflected light may be similarly generated not only from the surface of the λ/4 plate 21 but also from the interface between the sealing resin 22 and the λ/4 plate 21 in the retroreflection module 200.

When the retroreflected light 13A2 that forms the air floating video 3 is regarded as regular video light, the specularly reflected light 13A4 generated by the λ/4 plate 21 is irregular video light that forms a ghost image with respect to the regular video light. This irregular video light 13A4 appears as a ghost image when the user visually recognizes the air floating video 3, and the visibility is lowered. Therefore, there is a need to reduce such irregular video light 13A4.

FIG. 13B is a schematic explanatory diagram for the generation of the ghost image due to the irregular video light (specularly reflected light) 13A4 in FIG. 13A. The irregular video light 13A4 generated by the retroreflection module 200 including the λ/4 plate 21 becomes a ghost image 13B1 with respect to the air floating video 3. This ghost image 13B1 is formed as a virtual image behind the retroreflector 2 when viewed from the side of the air floating video 3 (side of the corresponding user).

FIG. 13C is a schematic explanatory diagram illustrating a configuration in which the inclination in the arrangement of the retroreflection module 200 with respect to the liquid crystal display panel 11 and the polarization separator 101 is changed as a solution to the problem illustrated in FIG. 13B. In FIG. 13C, the retroreflection module 200 is arranged so as to be rotated by a predetermined angle (θ) with respect to the arrangement in FIG. 13B around an optical axis 13C1 of the light emitted from the liquid crystal display panel 11, that is, an optical axis of the corresponding reflected light from the polarization separator 101 and an optical axis 13C2 of the retroreflected light 13A2 as the center of rotation. The rotated angle is defined as 0. In this arrangement, an optical axis 13C3 of the ghost image 13B1 formed by the irregular video light 13A4 is inclined by an angle 2θ with respect to the optical axis 13C2 of the retroreflected light 13A2 that forms the air floating video 3. As a result, the ghost image 13B1 moves out of the field of view in the direction in which the user views the air floating video 3, and the decrease in visibility of the air floating video 3 due to the ghost image 13B1 is reduced.

FIG. 13D is an explanatory diagram for the angle θ in the arrangement in FIG. 13C and the angles formed by respective components. In FIG. 13D, the arrangement angles of the components in the arrangement state (FIG. 13B) in which the ghost image 13B1 due to the irregular video light 13A4 is strongly visually recognized are indicated by angles A, B, and C. The angle A is the angle formed by the video display apparatus 1 including the liquid crystal display panel 11 (in particular, video light emission surface) and the polarization separator 101 (in particular, reflection surface). The angle β is the angle formed by the polarization separator 101 (in particular, reflection surface) and the retroreflection module 200 (in particular, surface of the λ/4 plate 21). The angle C is the angle formed by the video display apparatus 1 including the liquid crystal display panel 11 (in particular, video light emission surface) and the retroreflection module 200 (in particular, surface of the λ/4 plate 21). For example, the angle C is about 90 degrees, and the angles A and B are each about 45 degrees.

Meanwhile, in the arrangement state in which the retroreflection module 200 is rotated by the angle θ (FIG. 13C), the angle B is changed to an angle B′ and the angle C is changed to an angle C′ as illustrated in the drawing. The relationship between the angle B and the angle B′ and the relationship between the angle C and the angle C′ are as follows. That is, the angle B′ is increased by the angle θ from the angle B, and the angle C′ is decreased by the angle θ from the angle C.

B′=B+θ Formula 1:

C′=C−θ Formula 2:

### <Ghost Image in Horizontally Mounted Housing>

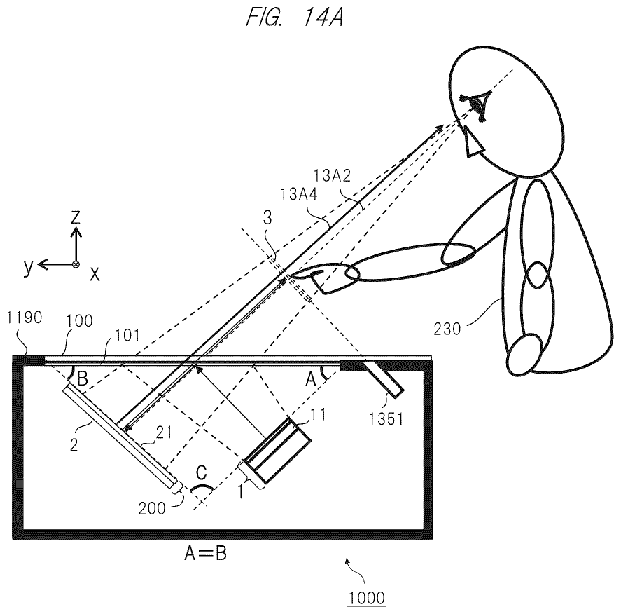

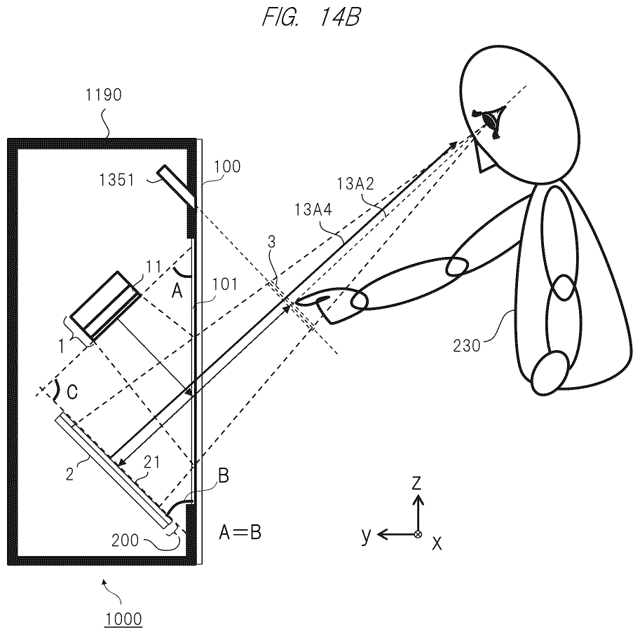

FIG. 14A is a schematic explanatory diagram illustrating the problem of the generation of the ghost image 13B1 due to the irregular video light 13A4 illustrated in FIG. 13A and others in a horizontally mounted housing as in the example of FIG. 4A described above. In FIG. 14A, the three components of the video display apparatus 1 including the liquid crystal display panel 11, the polarization separator 101, and the retroreflection module 200 are arranged so as to form the angles A, B, and C as with FIG. 13D. In this configuration, the angle A and the angle β are approximately equal to each other.

As illustrated in the configuration of FIG. 14A, when the angle A and the angle B are approximately equal to each other in the relationship of the angles (A, B, C) formed by the three components of the liquid crystal display panel 11, the polarization separator 101, and retroreflection module 200 including the λ/4 plate 21, the irregular video light 13A4 caused by the specularly reflected light from the λ/4 plate 21 overlaps with the regular video light 13A2 that forms the air floating video 3. As a result, in the direction in which the air floating video 3 is viewed from the viewpoint of the user 230, the ghost image 13B1 caused by the irregular video light 13A4 is generated on the opposite side of the air floating video 3, behind the retroreflection module 200, as also illustrated in FIG. 13B. The ghost image 13B1 overlapping with the air floating video 3 causes the decrease in visibility of the air floating video 3 viewed from the user 230.

### <Ghost Image in Vertically Mounted Housing>

Similarly, FIG. 14B is a schematic explanatory diagram illustrating the problem of the generation of the ghost image 13B1 due to the irregular video light 13A4 illustrated in FIG. 13A and others in a vertically mounted housing as in the example of FIG. 4B described above. In FIG. 14B as well, the three components are arranged so as to form the angles A, B, and C as with FIG. 13D. In this configuration, the angle A and the angle B are approximately equal to each other. In the case of this configuration as well, the irregular video light 13A4 due to the specularly reflected light from the λ/4 plate 21 overlaps with the regular video light 13A2 that forms the air floating video 3. As a result, in the direction in which the air floating video 3 is viewed from the viewpoint of the user 230, the ghost image 13B1 caused by the irregular video light 13A4 is generated on the opposite side of the air floating video 3, behind the retroreflection module 200, as also illustrated in FIG. 13B. The ghost image 13B1 overlapping with the air floating video 3 causes the decrease in visibility of the air floating video 3 viewed from the user 230.

### <Example 1A for Reducing Ghost Image in Horizontally Mounted Housing>

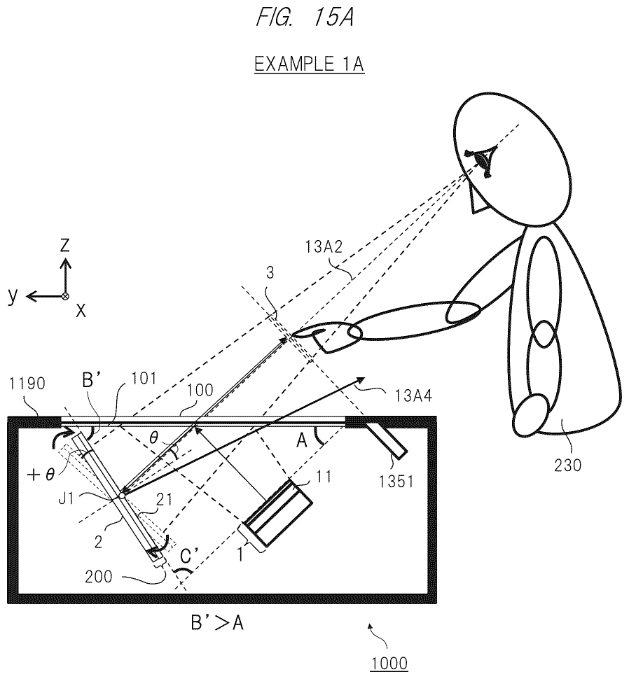

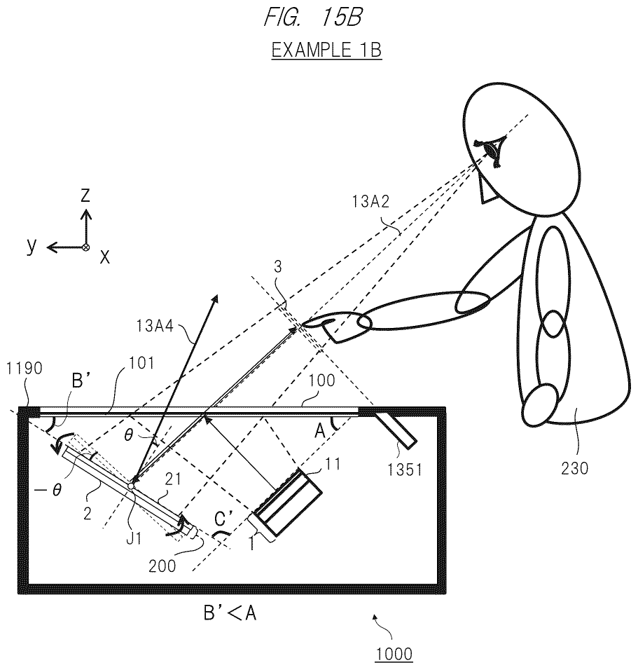

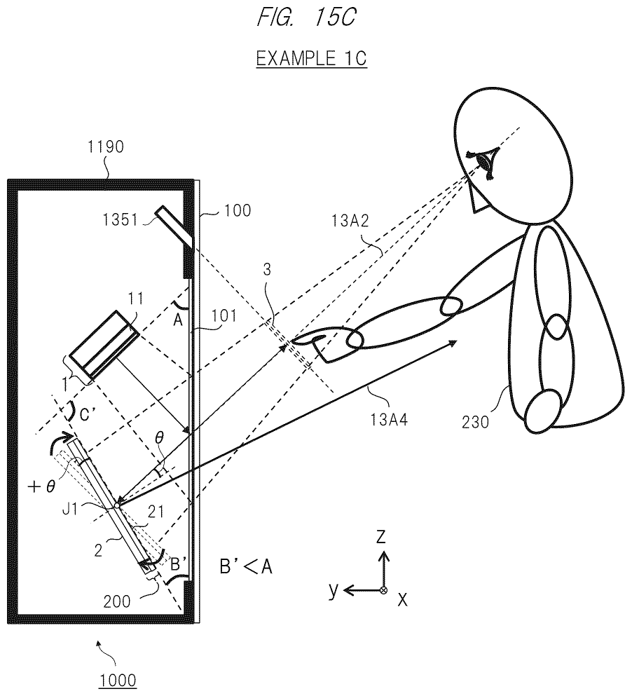

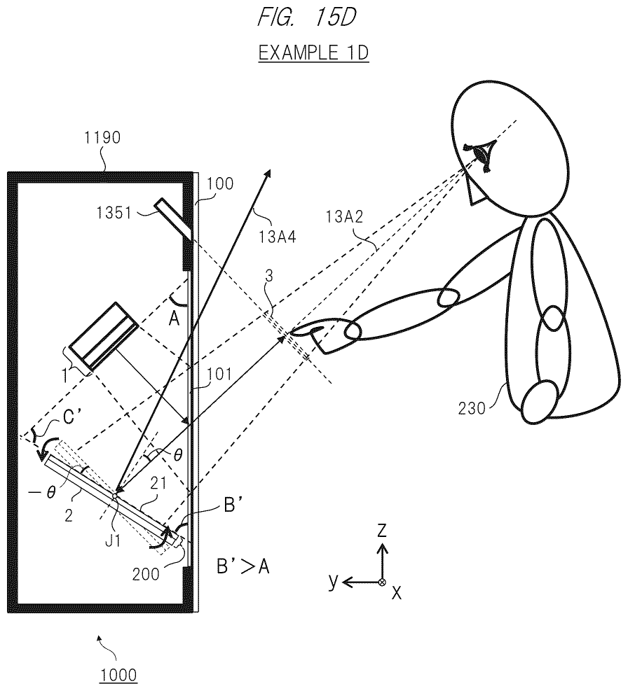

FIG. 15A illustrates a configuration of an air floating video display apparatus of an example 1A as a first example for reducing the ghost image in a horizontally mounted housing. As with the above-mentioned FIG. 4A, this example 1A has the configuration in which the video display apparatus 1 including the liquid crystal display panel 11, the polarization separator 101, and the retroreflection module 200 including the λ/4 plate 21 are arranged in the horizontally mounted housing 1190. In this configuration, the retroreflection module 200 is arranged to be inclined by an angle θ such that the angle B (B′) that the retroreflection module 200 forms with respect to the polarization separator 101 is larger than the angle A that the liquid crystal display panel 11 forms with respect to the polarization separator 101 (B′>A). As a result of the change to the angle A′, the angle C is also changed to the angle C′ (A+B′+C′=180 degrees).

The irregular video light 13A4 of the retroreflection module 200 passes through an optical path below (below in the Z direction in the drawing) the regular video light 13A2 that forms the air floating video 3. As a result, the irregular video light 13A4 moves out of the field of view of the user 230, that is, the optical axis of the regular video light 13A2, and the ghost image 13B1 due to the irregular video light 13A4 moves out to the optical axis 13C3 inclined by an angle 2θ with respect to the optical axis 13C2 of the air floating video 3 as illustrated in FIG. 13C described above. Therefore, when viewed from the user 230, the overlap of the ghost image 13B1 with the air floating video 3 is reduced, and the visibility of the air floating video 3 can be improved.

Even if the retroreflection module 200 is rotated by the angle θ, the direction of the regular video light 13A2 by the retroreflected light from the retroreflection module 200 does not change between when it enters and when it is emitted because of the characteristics of the retroreflection module 200. Meanwhile, the direction of the irregular video light 13A4 is changed by the angle of 2θ. Therefore, the direction of the irregular video light 13A4 can be made different from the direction of the regular video light 13A2.

Note that a rotation axis J1 of the rotation by the angle θ is located at a position corresponding to the optical axis of the regular video light 13A2 on the surface of the λ/4 plate 21, and extends in the x direction.

In the configuration of FIG. 15A, the irregular video light 13A4 from the λ/4 plate 21 passes through the polarization separator 101 and the transparent member 100, and is emitted to the outside of the housing 1190. As the irregular video light 13A4 travels outward along the optical path, the irregular video light 13A4 (its optical axis) moves away from the regular video light 13A2 (its optical axis).

In the air floating video display apparatus of the example 1A, as illustrated in the principle diagram (FIG. 13C), by the configuration in the which arrangement angle B′ of the retroreflection module 200 is made different from the angle A, the irregular video light 13A4 from the retroreflection module 200 travels in a direction deviated from the direction of the regular video light 13A2. Therefore, when viewed from the viewpoint of the user 230, the ghost image 13B1 due to the irregular video light 13A4 is formed at a position deviated from the air floating video 3 formed by the regular video light 13A2, so that the visual recognition of the ghost image 13B1 can be reduced. In other words, when viewed from the user 230, the overlap of the ghost image 13B1 with the air floating video 3 can be reduced, and the visibility of the air floating video 3 can be improved.

### <Example 1B for Reducing Ghost Image in Horizontally Mounted Housing>

FIG. 15B illustrates a configuration of an air floating video display apparatus of an example 1B as a second example for reducing the ghost image in a horizontally mounted housing. The configuration of FIG. 15B is different from the configuration of FIG. 15A in that the retroreflection module 200 is arranged to be inclined by the angle θ (−θ in FIG. 15B when angle θ in FIG. 15A is defined as +θ) such that the angle B (B′) that the retroreflection module 200 forms with respect to the polarization separator 101 is smaller than the angle A that the liquid crystal display panel 11 forms with respect to the polarization separator 101 (B′<A).

In the configuration of FIG. 15B, in contrast to the configuration of FIG. 15A, the irregular reflected light 13A4 of the retroreflection module 200 passes through an optical path above (above in the Z direction in the drawing) the regular video light 13A2 that forms the air floating video 3. As a result, the irregular video light 13A4 moves out of the field of view of the user 230, that is, the optical axis of the regular video light 13A2, and the ghost image 13B1 due to the irregular video light 13A4 moves out to the optical axis 13C3 inclined by an angle 2θ with respect to the optical axis 13C2 of the air floating video 3 like the case in which the direction of rotation by the angle θ in FIG. 13C described above is reversed. Therefore, when viewed from the user 230, the overlap of the ghost image 13B1 with the air floating video 3 is reduced, and the visibility of the air floating video 3 can be improved.

### <Example 1C for Reducing Ghost Image in Vertically Mounted Housing>

FIG. 15C illustrates a configuration of an air floating video display apparatus of an example 1C as a third example for reducing the ghost image in a vertically mounted housing. As with the above-mentioned FIG. 4B, this example 1C has the configuration in which the video display apparatus 1 including the liquid crystal display panel 11, the polarization separator 101, and the retroreflection module 200 including the λ/4 plate 21 are arranged in the vertically mounted housing 1190. In this configuration, the retroreflection module 200 is arranged to be inclined by an angle θ such that the angle B (B′) that the retroreflection module 200 forms with respect to the polarization separator 101 is smaller than the angle A that the liquid crystal display panel 11 forms with respect to the polarization separator 101 (B′<A).

In this configuration, the irregular video light 13A4 of the retroreflection module 200 passes through an optical path below (below in the Z direction in the drawing) the regular video light 13A2 that forms the air floating video 3. As a result, the irregular video light 13A4 moves out of the field of view of the user 230, that is, the optical axis of the regular video light 13A2, and the ghost image 13B1 due to the irregular video light 13A4 moves out to the optical axis 13C3 inclined by an angle 2θ with respect to the optical axis 13C2 of the air floating video 3 as illustrated in FIG. 13C described above. Therefore, when viewed from the user 230, the overlap of the ghost image 13B1 with the air floating video 3 is reduced, and the visibility of the air floating video 3 can be improved.

### <Example 1D for Reducing Ghost Image in Vertically Mounted Housing>

FIG. 15D illustrates a configuration of an air floating video display apparatus of an example 1D as a fourth example for reducing the ghost image in a horizontally mounted housing. The example 1D is different from the configuration of FIG. 15C in that the retroreflection module 200 is arranged to be inclined by the angle θ (−θ in FIG. 15D when angle θ in FIG. 15C is defined as +θ) such that the angle B (B′) that the retroreflection module 200 forms with respect to the polarization separator 101 is larger than the angle A that the liquid crystal display panel 11 forms with respect to the polarization separator 101 (B′>A).

In the configuration of FIG. 15D, in contrast to the configuration of FIG. 15C, the irregular reflected light 13A4 of the retroreflection module 200 passes through an optical path above (above in the Z direction in the drawing) the regular video light 13A2 that forms the air floating video 3. As a result, the irregular video light 13A4 moves out of the field of view of the user 230 (the optical axis of the regular video light 13A2), and the ghost image 13B1 due to the irregular video light 13A4 moves out to the optical axis 13C3 inclined by an angle 2θ with respect to the optical axis 13C2 of the air floating video 3 like the case in which the direction of rotation by the angle θ in FIG. 13C described above is reversed. Therefore, when viewed from the user 230, the overlap of the ghost image 13B1 with the air floating video 3 is reduced, and the visibility of the air floating video 3 can be improved.

<Examples Provided with Light-Blocking Portion for Irregular Video Light>

Next, based on the above-mentioned examples 1A to 1D, examples in which a light-blocking portion for the above-mentioned irregular video light 13A4 (ghost image 13B1) is provided as a further contrivance will be described.

<Example 2A Provided with Light-Blocking Portion>

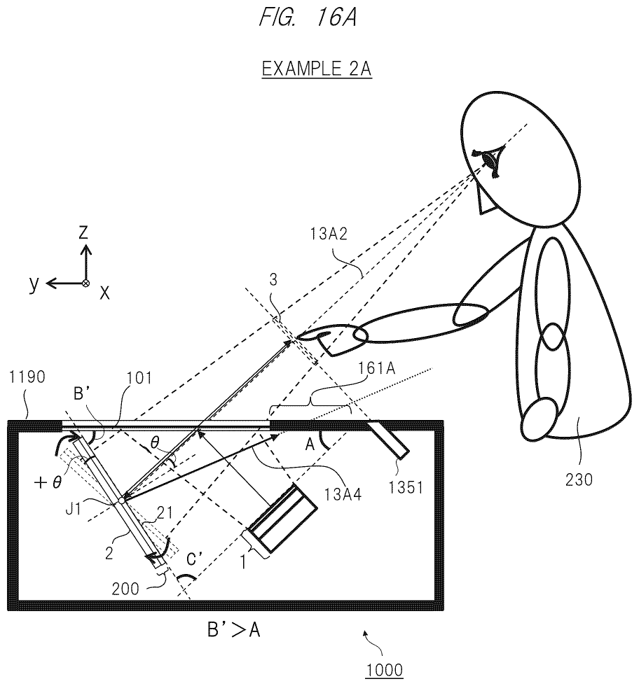

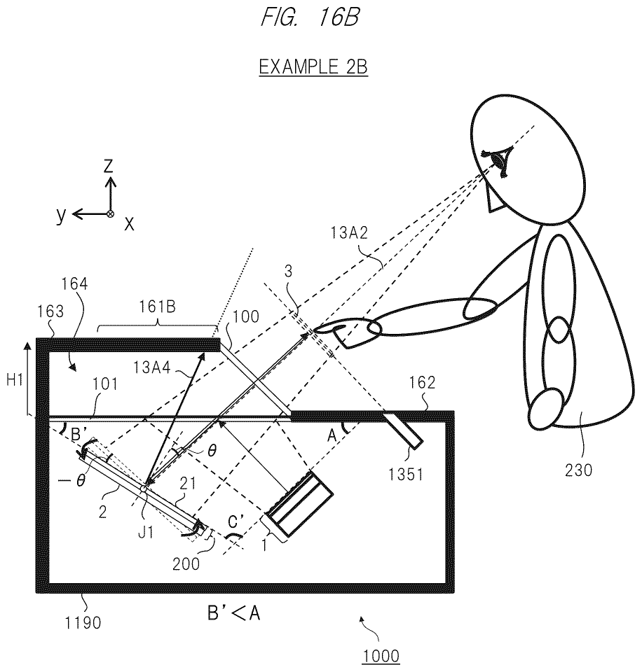

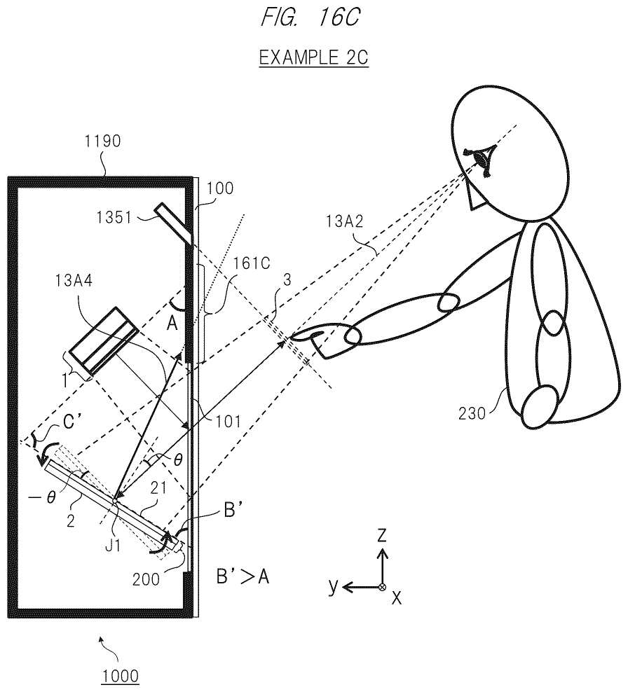

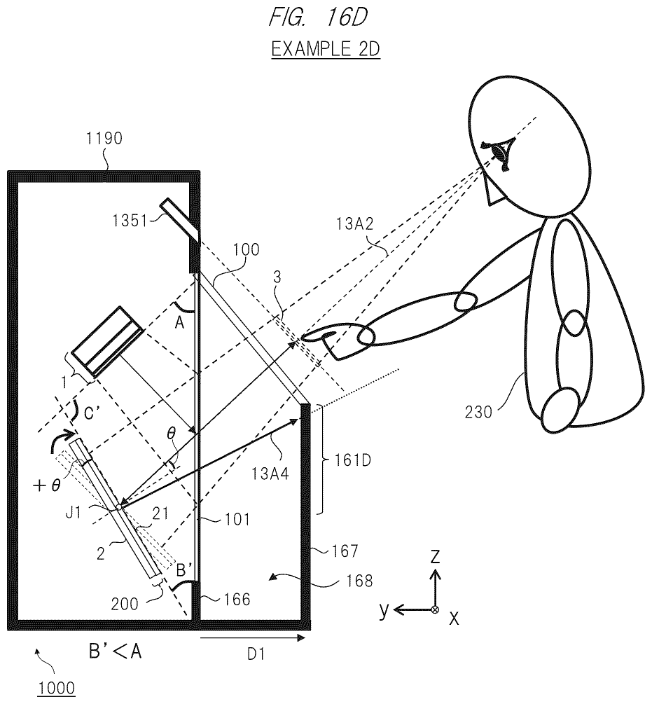

FIG. 16A illustrates a configuration of an air floating video display apparatus of an example 2A as a first example provided with a light-blocking portion in a horizontally mounted housing. The configuration of the example 2A in FIG. 16A is based on the configuration of the example 1A in FIG. 15A, and has common components. The configuration of FIG. 16A is different from the configuration of FIG. 15A in that a light-blocking portion 161A is provided in a part of the housing 1190. In the configuration of FIG. 15A, a region where the polarization separator 101 and the transparent member 100 are arranged is provided on an upper surface of the housing 1190, and the regular video light 13A2 passes through this region to the outside. In addition, the irregular video light 13A4 (its optical axis) also passes through this region to the outside. Meanwhile, in the configuration of FIG. 16A, the region where the polarization separator 101 and the transparent member 100 are arranged on the upper surface of the housing 1190 is narrowed by providing the light-blocking portion 161A. The regular video light 13A2 passes through this region to the outside, but the irregular video light 13A4 (its optical axis) is shieled by the light-blocking portion 161A in this region and does not pass through to the outside. Namely, the light-blocking portion 161A is provided in the region that blocks the irregular video light 13A4 that forms a ghost image, but does not block the regular video light 13A2 that forms an air floating video.

In other words, in this example 2A, a range on the upper surface of the housing 1190 through which the light flux of the regular video light 13A2 by the retroreflected light from the retroreflection module 200 passes is configured as an opening made of a transmissive member, that is, the polarization separator 101 and the transparent member 100, and a part of the housing 1190 is configured as the light-blocking portion 161A so as to block only the irregular video light 13A4. This reduces the degree to which the light flux of the irregular video light 13A4 enters the field of view of the user 230, so that this example 2A can further reduce the decrease in visibility due to the ghost image 13B1 as compared with the example 1A. In other words, a transparent member is provided in the housing so as to correspond to the region where the polarization separator is arranged, and a light-blocking member is provided in a region that does not block the video light that forms an air floating video in the region through which the axis perpendicular to the surface of the retroreflection module passes. The same applies to the light-blocking portions described below.

Note that the aerial operation detection sensor 1351 is not shielded by the light-blocking portion 161A of the housing 1190, and performs the sensing of the surface of the air floating video 3 in the same manner as described above.

<Example 2B Provided with Light-Blocking Portion>

FIG. 16B illustrates a configuration of an air floating video display apparatus of an example 2B as a second example provided with a light-blocking portion in a horizontally mounted housing. The configuration of the example 2B in FIG. 16B is based on the configuration of the example 1B in FIG. 15B, and has common components. The configuration of FIG. 16B is different from the configuration of FIG. 15B in that a light-blocking portion 161B is provided in a part of the housing 1190. In the configuration of FIG. 15B, a region where the polarization separator 101 and the transparent member 100 are arranged is provided on the upper surface of the housing 1190, and the regular video light 13A2 passes through this region to the outside. In addition, the irregular video light 13A4 (its optical axis) also passes through this region to the outside. Meanwhile, in the configuration of FIG. 16B, a region where the polarization separator 101 is arranged is provided on an upper surface 162 of the housing 1190, and both the regular video light 13A2 and the irregular video light 13A4 (their optical axes) pass through this region to the outside. In the configuration of FIG. 16B, the housing 1190 is provided with an upper surface 163 as a second upper surface at a position of height H1 above the upper surface 162 with a space 164 therebetween. Further, the transparent member 100 is arranged on an inclined surface so as to connect the upper surface 162 and the upper surface 163.

In this configuration, if a light-blocking portion for blocking the irregular video light 13A4 is provided in the region where the polarization separator 101 is arranged on the upper surface 162, the light flux of the regular video light 13A2 would also be blocked, and thus the light-blocking portion 161B is provided as a part of the housing 1190 on the upper surface 163 located at a higher position. As illustrated in the drawing, the light-blocking portion 161B blocks the irregular video light 13A4 (its optical axis) without blocking the light flux of the regular video light 13A2. The light flux of the regular video light 13A2 passes through the polarization separator 101 and the transparent member 100 to the outside. The irregular video light 13A4 is blocked by the light-blocking portion 161B after passing through the polarization separator 101. This reduces the degree to which the light flux of the irregular video light 13A4 enters the field of view of the user 230, so that this example 2B can further reduce the decrease in visibility due to the ghost image 13B1 as compared with the example 1B. In other words, the housing has the transparent member on a first housing surface, that is, the upper surface 162 and the light-blocking portion on a second housing surface, that is, the upper surface 163 separated outward from the first housing surface by a predetermined distance.

Note that the space 164 provided between the upper surface 162 and the upper surface 163 can be used for any purpose such as arranging other members. For example, the aerial operation detection sensor 1351 may be arranged in this space 164.

<Example 2C Provided with Light-Blocking Portion>

FIG. 16C illustrates a configuration of an example 2C as a third example provided with a light-blocking portion in a vertically mounted housing. FIG. 16C is different from the configuration of FIG. 15D in that a light-blocking portion 161C is provided on a part of a front surface of the housing 1190. The light-blocking portion 161C is provided at a position where the irregular video light 13A4 (its optical axis) passes, and blocks the irregular video light 13A4 (its optical axis) without blocking the light flux of the regular video light 13A2. This reduces the degree to which the light flux of the irregular video light 13A4 enters the field of view of the user 230, so that this example 2C can further reduce the decrease in visibility due to the ghost image 13B1 as compared with the example 1D.

<Example 2D Provided with Light-Blocking Portion>

FIG. 16D illustrates a configuration of an example 2D as a fourth example provided with a light-blocking portion in a vertically mounted housing. The example 2D is an example in which the light-blocking portion similar to that of the example 2B is applied to a vertically mounted housing. FIG. 16D is different from the configuration of FIG. 15C in that a region in which the polarization separator 101 is arranged is provided on a front surface 166 of the housing 1190 and both the regular video light 13A2 and the irregular video light 13A4 (their optical axes) pass through this region to the outside. In the configuration of FIG. 16D, the housing 1190 is provided with a front surface 167 as a second front surface at a position of distance D1 in front of the front surface 166 with a space 168 therebetween. Further, the transparent member 100 is arranged on an inclined surface so as to connect the front surface 166 and the front surface 167.

In this configuration, if a light-blocking portion for blocking the irregular video light 13A4 is provided in the region where the polarization separator 101 is arranged on the front surface 166, the light flux of the regular video light 13A2 would also be blocked, and thus the light-blocking portion 161D is provided as a part of the housing 1190 on the front surface 167 located at a further front position. As illustrated in the drawing, the light-blocking portion 161D blocks the irregular video light 13A4 (its optical axis) without blocking the light flux of the regular video light 13A2. The light flux of the regular video light 13A2 passes through the polarization separator 101 and the transparent member 100 to the outside. The irregular video light 13A4 is blocked by the light-blocking portion 161D after passing through the polarization separator 101. This reduces the degree to which the light flux of the irregular video light 13A4 enters the field of view of the user 230, so that this example 2D can further reduce the decrease in visibility due to the ghost image 13B1 as compared with the example 1C.

Note that the space 168 provided between the front surface 166 and the front surface 167 can be used for any purpose such as arranging other members. For example, the aerial operation detection sensor 1351 may be arranged in this space 168.

<Examples Provided with Holding Unit>

Next, examples in which a holding unit for attaching and holding the video display apparatus 1, the polarization separator 101, and the retroreflection module 200 is provided in the housing 1190 of the air floating video display apparatus of the above examples will be described.

<Example 3A Provided with Holding Unit>

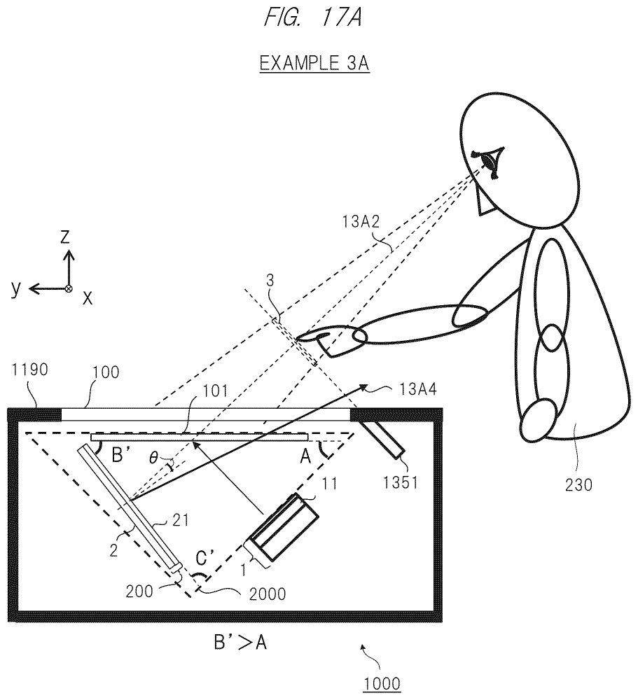

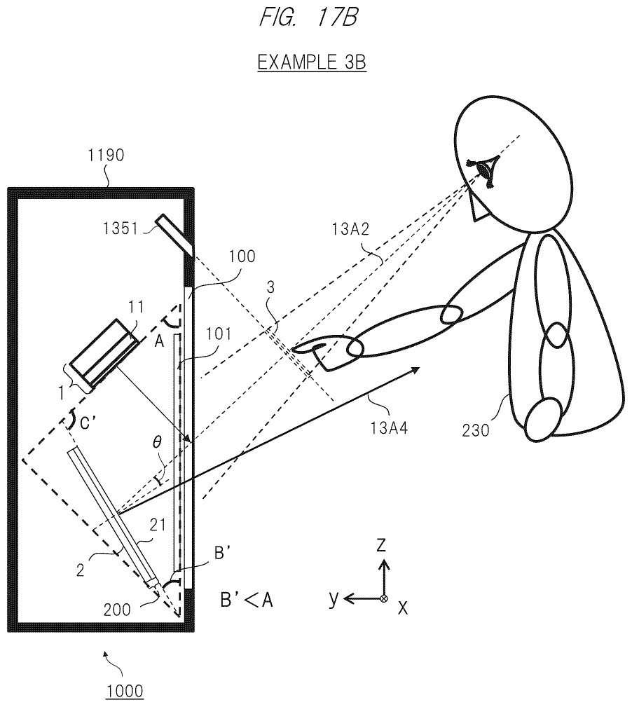

FIG. 17A illustrates a configuration of an air floating video display apparatus of an example 3A as an example in which a predetermined holding unit 2000 is provided in the case of, for example, the horizontally mounted housing 1190 (example 1A in FIG. 15A or the like). In this example 3A, the components of the video display apparatus 1, the polarization separator 101, and the retroreflection module 200 including the λ/4 plate 21 are held in a predetermined positional relationship by the holding unit 2000. The holding unit 2000 is attached so as to be held by the housing 1190. The predetermined positional relationship includes the above-mentioned angular relationship.

In FIG. 17A, an outline of the shape of the holding unit 2000 is illustrated by dashed lines, and details thereof will be described later. On the illustrated y-z plane in the drawing, the video display apparatus 1 is held on a first surface of the holding unit 2000, the polarization separator 101 is held on a second surface of the holding unit 2000, and the retroreflection module 200 is held on a third surface of the holding unit 2000. The second surface of the holding unit 2000 is arranged in parallel to the surface of the transparent member 100 on the upper surface of the housing 1190. As with the case described above (for example, example 1A in FIG. 15A), the surface of the liquid crystal display panel 11 is held so as to form the angle A with respect to the surface of the polarization separator 101, and the surface of the λ/4 plate 21 of the retroreflection module 200 is held so as to form the angle B′ with respect to the surface of the polarization separator 101 (for example, B′>A). With this holding unit 2000, the three components can be stably held while maintaining a predetermined angular relationship.

<Example 3B Provided with Holding Unit>

FIG. 17B illustrates a configuration of an air floating video display apparatus of an example 3B as an example in which a predetermined holding unit 2000 is provided in the case of, for example, the vertically mounted housing 1190 (example 1C in FIG. 15C or the like). In this example 3B, the three components described above are held in a predetermined positional relationship by the holding unit 2000 as with the example 3A. The holding unit 2000 is attached so as to be held by the housing 1190. On the illustrated y-z plane, the video display apparatus 1 is held on the first surface of the holding unit 2000, the polarization separator 101 is held on a second surface of the holding unit 2000, and the retroreflection module 200 is held on a third surface of the holding unit 2000. The second surface of the holding unit 2000 is arranged in parallel to the surface of the transparent member 100 on the front surface of the housing 1190. As with the case described above (for example, example 1C in FIG. 15C), the surface of the liquid crystal display panel 11 is held so as to form the angle A with respect to the surface of the polarization separator 101, and the surface of the λ/4 plate 21 of the retroreflection module 200 is held so as to form the angle B′ with respect to the surface of the polarization separator 101 (for example, B′<A). With this holding unit 2000, the three components can be stably held while maintaining a predetermined angular relationship.

### <Example of Structure of Holding Unit: Example 4A>

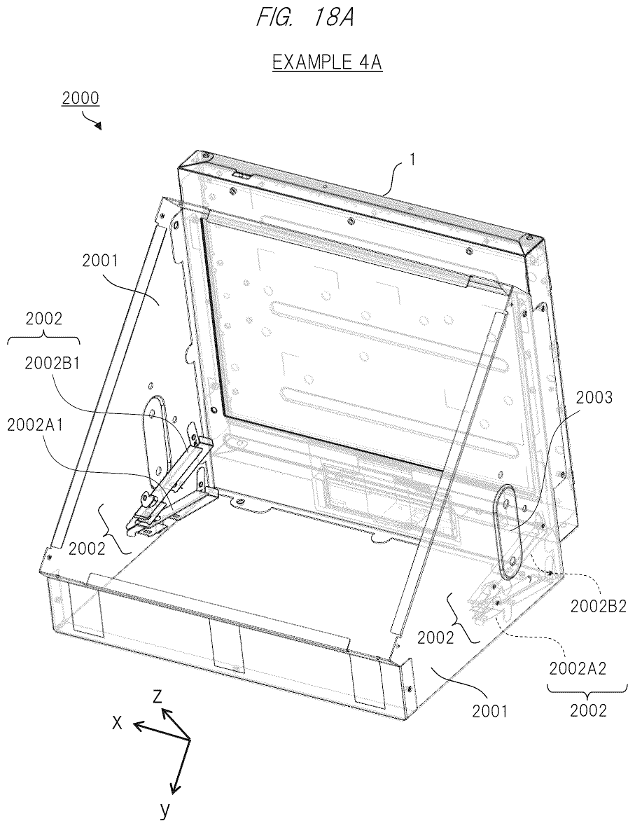

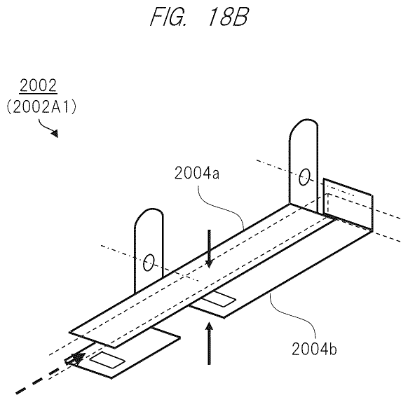

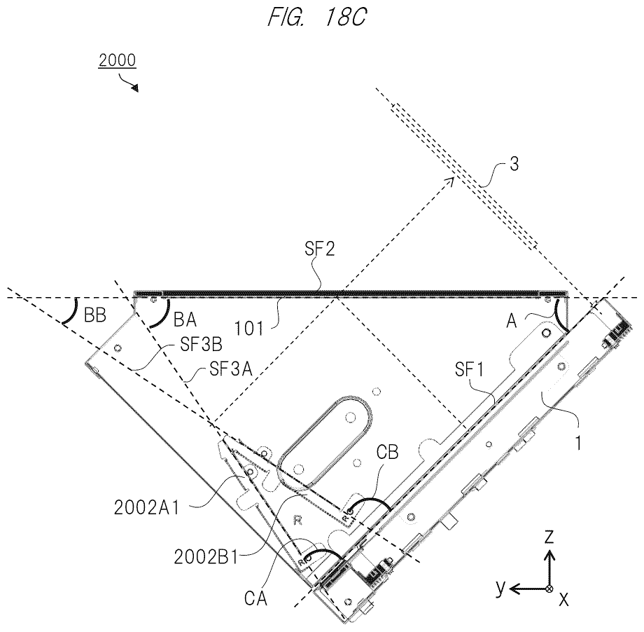

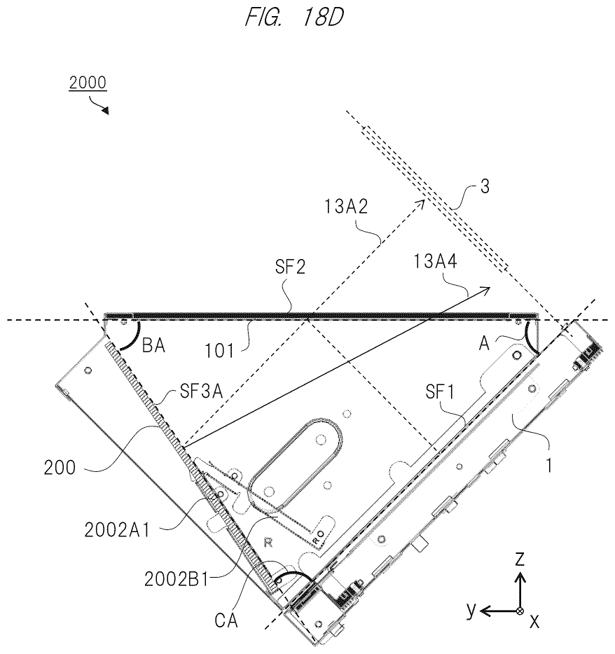

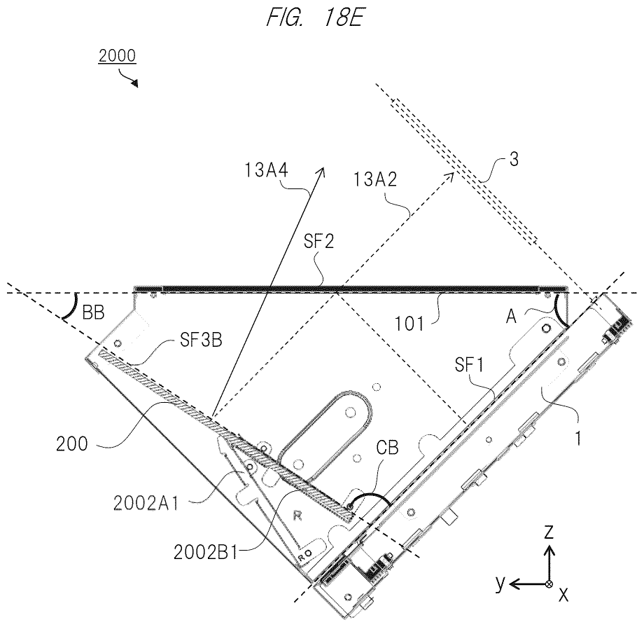

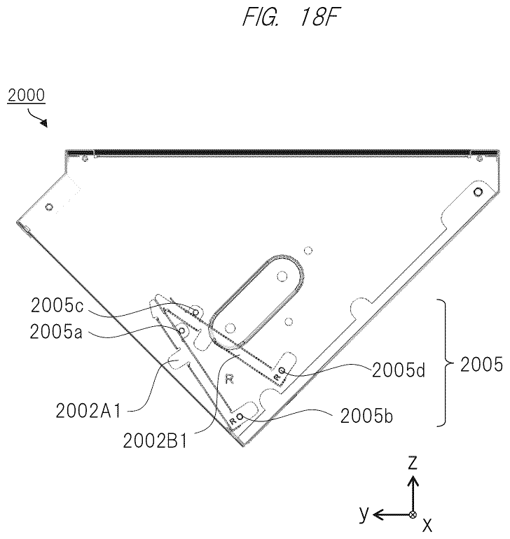

FIG. 18A is a perspective view illustrating a detailed example of a structure of the holding unit 2000 in FIG. 17A and FIG. 17B as an example 4A. FIG. 18A illustrates a state in which only the video display apparatus 1 is attached to the holding unit 2000. This holding unit 2000 has a first surface, a second surface, and a third surface for holding the three components mentioned above, that is, the video display apparatus 1, the polarization separator 101, and the retroreflection module 200, and a side surface portion 2001, in other words, a side cover arranged on, for example, the y-z plane of the housing 1190 in FIG. 17A. Three sides of the roughly triangular surface of the side surface portion 2001 are adjacent to the corresponding sides of the first surface, the second surface, and the third surface. The video display apparatus 1 is fixed to the first surface of the holding unit 2000. The above-mentioned polarization separator 101 is fixed to the second surface of the holding unit 2000. The retroreflection module 200 is fixed to the third surface of the holding unit 2000 using a holding member 2002. The holding unit has the side surface portion that holds the first surface, the second surface, and the third surface, and has the holding member on the side surface portion for attaching the retroreflection module at the second angle, that is, the angle that the retroreflection module forms with respect to the polarization separator.

In the holding unit 2000, the holding members 2002 are fixed to the side surface portions 2001 located at the front and rear positions in the x direction. The holding member 2002 is a member for attaching and holding the retroreflection module 200. Two holding members 2002 are fixed to each side surface portion 2001. For example, one side surface portion 2001 (left side in FIG. 18A) has a first holding member 2002A1 and a second holding member 2002B1 internally, and the other side surface portion 2001 (right side in FIG. 18A) has a first holding member 2002A2 and a second holding member 2002B2 internally. In other words, a first holding member for attaching the retroreflection module at the second angle larger than the first angle that the video display apparatus forms with respect to the polarization separator, that is, at the angle that the retroreflection module forms with respect to the polarization separator and a second holding member for attaching the retroreflection module at the second angle smaller than the first angle that the video display apparatus forms with respect to the polarization separator, that is, at the angle that the retroreflection module forms with respect to the polarization separator are provided in the side surface portion. Also, the first holding member and the second holding member are parts having the same shape and structure.

Each holding member 2002 is fixed to the side surface portion 2001 (its screw holes and others) by, for example, screwing. Also, each side surface portion 2001 also has an attachment portion 2003 for attaching the holding unit 2000 to the housing 1190. The side surface portion may have a holding member for attaching the retroreflection module at the second angle larger than the first angle that the video display apparatus forms with respect to the polarization separator, that is, at the angle that the retroreflection module forms with respect to the polarization separator or may have a holding member for attaching the retroreflection module at the second angle smaller than the first angle that the video display apparatus forms with respect to the polarization separator, that is, at the angle that the retroreflection module forms with respect to the polarization separator.

In this example 4A, the holding unit 2000 is provided with the plurality of holding members 2002 such that the retroreflection module 200 can be arranged at an angle selected from two types of angles (the above-mentioned angles B′). For example, when the retroreflection module 200 is arranged at a first type of angle (for example, the angle B′ in the example 1A in FIG. 15A), the holding member 2002A1 and the holding member 2002A2 are selected, and when the retroreflection module 200 is arranged at a second type of angle (for example, the angle B′ in the example 1B in FIG. 15B), the holding member 2002B1 and the holding member 2002B2 are selected. As described above, the angle C′ is also determined according to the angle B′.

FIG. 18B is a schematic diagram illustrating an outline of the structure of one holding member 2002 (for example, the holding member 2002A1). Each holding member 2002 is made up of a pair of structures. For example, the holding member 2002A1 is made up of a holding structure 2004a and a holding structure 2004b. The upper holding structure 2004a and the lower holding structure 2004b are each a roughly plate-shaped structure, and are each fixed to the side surface portion 2001 by screwing. The lower holding structure 2004b has a stopper on the far side (the side closer to the first surface). Between the upper holding structure 2004a and the lower holding structure 2004b, a space or groove is provided at a predetermined distance.

When the retroreflection module 200 is attached to the holding member 2002, an end of the retroreflection module 200 is inserted into a groove formed by the holding structures 2004a and 2004b of the holding member 2002 in the direction indicated by the arrow in the drawing. As the retroreflection module 200 is inserted, the end thereof abuts to the stopper of the holding structure 2004b on the far side of the holding member 2002. The part of the retroreflection module 200 inserted between the upper holding structure 2004a and the lower holding structure 2004b is held by being sandwiched from above and below and pressed by the leaf springs thereof.

After one part of the retroreflection module 200 is inserted into the holding member 2002 in the same manner in each side surface portion 2001, another part of the retroreflection module 200 (the side closer to the second surface) is fixed by, for example, a cushioning material and a lid so as to prevent the module from moving in the main surface direction. In this way, the retroreflection module 200 is fixed at a selected angle to the holding member 2002 close to the third surface.

Each of the four holding members 2002 (for example, the holding members 2002A1, 2002B1, 2002A2, and 2002B2) is configured as the same parts having the same shape and others, and the same part can be applied regardless of the position at which it is attached.

FIG. 18C illustrates the two types of angles in the cross-sectional view (y-z plane) of the holding unit 2000 described above. Note that FIG. 18C illustrates the holding members 2002A1 and 2002B1 of one side surface portion 2001 out of the holding members 2002 of the two side surface portions 2001 in FIG. 18A, but the holding members 2002A2 and 2002B2 of the other side surface portion 2001 are also arranged at the same corresponding positions. FIG. 18C illustrates the angle A that the first surface SF1 of the video display apparatus 1 forms with respect to the second surface SF2 to which the polarization separator 101 in the holding unit 2000 is fixed, an angle BA that the holding member 2002A1 (in particular, surface SF3A) forms with respect to the second surface SF2 of the polarization separator 101, an angle CA formed by the first surface SF1 of the video display apparatus 1 and the holding member 2002A1 (surface SF3A), an angle BB that the holding member 2002B1 (in particular, surface SF3B) forms with respect to the second surface SF2 of the polarization separator 101, and an angle CB formed by the first surface SF1 of the video display apparatus 1 and the holding member 2002B1 (surface SF3A).

The angle A that the video display apparatus 1 forms with respect to the second surface SF2 of the polarization separator 101, the angle BA that the holding member 2002A1 forms with respect to the second surface SF2, and the angle BB that the holding member 2002B1 forms with respect to the second surface SF2 are all different from each other (A+BA #BB), the angle BA is larger than the angle A (BA>A), and the angle BB is smaller than the angle A (BB<A).

When the holding member 2002A1 that forms the angle BA and the angle CA is selected as the arrangement of the retroreflection module 200 from the two types of holding members 2002, this corresponds to the arrangement (angle B′>A) in the example 1A in FIG. 15A described above or the like. When the holding member 2002B1 that forms the angle BB and the angle CB is selected, this corresponds to the arrangement (angle B′<A) of the example 1B in FIG. 15B described above or the like.

FIG. 18D illustrates a state in which the retroreflection module 200 is inserted and attached to the holding members 2002A1 and 2002A2 corresponding to the angle BA, out of the two types of holding members 2002 in the holding unit 2000 in FIG. 18C. The λ/4 plate 21 of the retroreflection module 200 is arranged along the surface SF3A corresponding to the holding member 2002A1. The retroreflection module 200 is arranged at the angle BA, and the irregular video light 13A4 is emitted through the optical path that is below the regular video light 13A2 by the angle 2θ described above.

FIG. 18E illustrates a state in which the retroreflection module 200 is inserted and attached to the holding members 2002B1 and 2002B2 corresponding to the angle BB, out of the two types of holding members 2002 in the holding unit 2000 in FIG. 18C. The λ/4 plate 21 of the retroreflection module 200 is arranged along the surface SF3B corresponding to the holding member 2002B1. The retroreflection module 200 is arranged at the angle BB, and the irregular video light 13A4 is emitted through the optical path that is above the regular video light 13A2 by the angle 2θ described above.

As described above, in the example 4A, depending on the implementation form of the air floating video display apparatus, the retroreflection module 200 can be attached by selecting one of the two types of holding members 2002 of the holding unit 2000 capable of forming the desired angle out of the two types of angles. The example 4A can cope with the implementation forms of the two types of angles by the single holding unit 2000.

FIG. 18F is an explanatory diagram for attachment holes (screw holes) 2005 provided in the side surface portion 2001 of the holding unit 2000. Each side surface portion 2001 is provided with attachment holes 2005a, 2005b, 2005c, and 2005d at predetermined positions as attachment holes (for example, screw holes capable of screwing) 2005 for attaching the two types of holding members 2002 described above. The holding unit 2000 may be configured as a unit in which the above-mentioned two types of holding members 2002 are fixed or a unit in which either one type of holding member 2002 is fixed, by using these attachment holes 2005, and can cope with each of these cases. Since the holding members 2002 for the two types of angles can be formed as parts having the same shape and structure with respect to the attachment holes 2005, the plurality of holding members 2002 can be manufactured and managed as one type of components.

As another example, a configuration in which only the holding member 2002 for one type of angle is attached to the holding unit 2000 described above is also possible.

### <Example of Structure of Holding Unit: Example 4B>

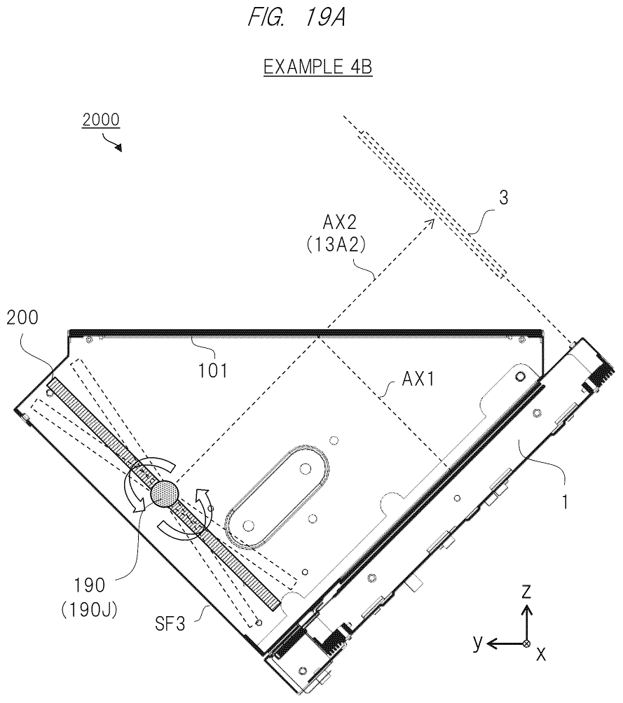

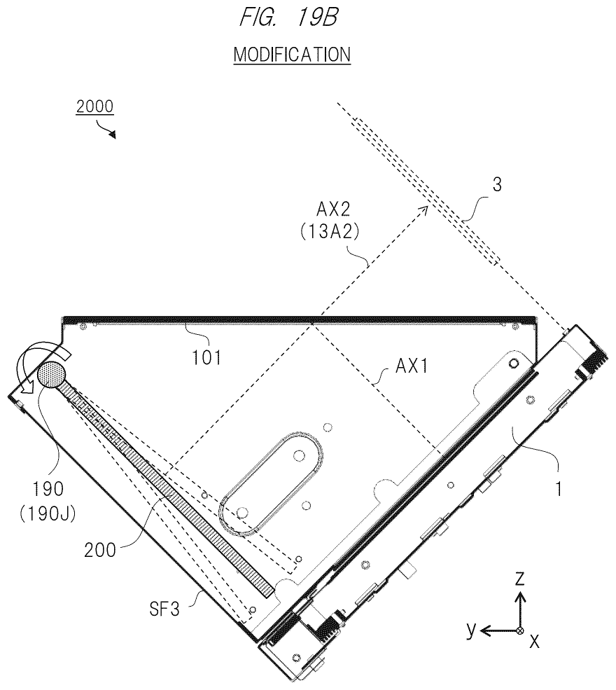

FIG. 19A illustrates a configuration of the holding unit 2000 as an example 4B. As a structure for arranging the retroreflection module 200 at a predetermined angle, the holding unit 2000 in the example 4B has a structure including a rotation mechanism different from the structure of the holding unit 2000 in the example 4A. In FIG. 19A, the holding unit 2000 includes a rotation mechanism 190 provided between the side surface portions 2001 and near the third surface SF3 on which the retroreflection module 200 is arranged. The rotation mechanism 190 is a mechanism that can rotate the held retroreflection module 200 around a rotation axis 190J. The rotation axis 190J is an axis extending in the x-direction. The rotation axis 190J of the rotation mechanism 190 is provided at a position that is approximately coincident with the position of an optical axis AX2 of the air floating video 3 (regular video light 13A2 corresponding thereto). The optical axis AX2 corresponds to the optical axis of the reflected light by the polarization separator 101 with respect to an optical axis AX1 of the video light from the liquid crystal display panel 11. The holding unit has the side surface portion that holds the above-mentioned first surface, second surface, and third surface, and the rotation mechanism for attaching the retroreflection module at the second angle, that is, the angle that the retroreflection module forms with respect to the polarization separator is provided on the side surface portion. The rotation mechanism has the rotation axis at a position corresponding to the position of the optical axis of the reflected video light from the polarization separator.

The retroreflection module 200 fixed to the rotation mechanism 190 can be rotated around the rotation axis 190J to be arranged at an angle selected from at least the two types of angles (BA, BB) mentioned above as illustrated by dashed lines. Furthermore, the rotation mechanism 190 may be a mechanism that can arrange the retroreflection module 200 at an angle set within the range of these angles without being limited to the two types of angles (BA, BB).

FIG. 19B illustrates a modification of the example 4B. The rotation mechanism 190 is not limited to the configuration in which the rotation axis 190J is provided at the position corresponding to the optical axis AX2 near the center of the retroreflection module 200, but may have the configuration in which the rotation axis 190J is provided at another position. In the configuration example of FIG. 19B, the rotation axis 190J is provided near one end of the third surface SF3 closer to the polarization separator 101 at one end of the retroreflection module 200. In this modification as well, the angle at which the retroreflection module 200 is arranged can be set to the two types of angles described above.

Regarding the rotation mechanism 190, in a case of the configuration in which the rotation axis 190J is provided at the position corresponding to the optical axis AX2 as with the example 4B, the distance on the optical axis through which the reflected video light from the polarization separator 101 enters is kept constant between the polarization separator 101 and the retroreflection module 200 even when the retroreflection module 200 is rotated at an angle of 10 with respect to the standard state of the retroreflection module 200. Therefore, in terms of design, the example 4B has an advantage over the modification in that the optical performance can be more easily controlled.

As described above, according to the air floating video display apparatus of the respective examples, the user 230 can visually recognize the air floating video 3 more favorably.

### <Arrangement Angle of Retroreflection Module>

The arrangement angle B′ of the retroreflection module 200 in the above-mentioned example 1A and others will be further described. As described above, the basic feature of the example 1A and others is in the configuration in which the angle B′ is different from the angle A unlike the conventional configuration in which the angle B is equal to the angle A (B=A). Regarding the arrangement angle of the retroreflection module 200, the configuration in which the angle B is equal to the angle A as illustrated in FIG. 14A and others is defined as the standard state. In this standard state, the surface of the λ/4 plate 21 which is the main surface of the retroreflection module 200 is perpendicular to the optical axis of the reflected video light from the polarization separator 101. Meanwhile, in the example 1A and others, the retroreflection module 200 is inclined forward or backward at the angle θ as described above, thereby obtaining the configuration in which the angle B′ is different from the angle A. In other words, the relationship illustrated in FIG. 13D, the formula 1, the formula 2, and others is made among the angles A, B′, and C′.

For example, the value of the angle B′ can be implemented as follows. In the normal state, the angles A and B are equal to each other and are, for example, 45 degrees. Of course, the angles A and B are not limited to 45 degrees. In the example 1A and others, the angle B′ is defined as an angle varied from the angle A (=45 degrees) by ±X degrees. In one example, when X is 11 degrees, the angle B′ is 56 degrees (B′=45 degrees+11 degrees). Of course, the angle X is not limited to this and may be any angle within a predetermined range (Xmin≤X≤Xmax).

In the technique according to the present example, by displaying the high-resolution and high-luminance video in the air floating state, for example, the user can operate without feeling anxious about contact infection of infectious diseases. If the technique according to the present embodiment is applied to a system used by an unspecified number of users, it will be possible to provide a non-contact user interface that can reduce the risk of contact infection of infectious diseases and can eliminate the feeling of anxiety. In this way, it is possible to contribute to “Goal 3: Ensure healthy lives and promote well-being for all at all ages” in the Sustainable Development Goals (SDGs) advocated by the United Nations.

In addition, in the technique according to the present embodiment, only the normal reflected light is efficiently reflected with respect to the retroreflection plate by making the divergence angle of the emitted video light small and aligning the light with a specific polarized wave, and thus a bright and clear air floating video can be obtained with high light utilization efficiency. With the technique according to the present embodiment, it is possible to provide a highly usable non-contact user interface capable of significantly reducing power consumption. In this way, it is possible to contribute to “Goal 9: Build resilient infrastructure, promote inclusive and sustainable industrialization and foster innovation” and “Goal 11: Make cities and human settlements inclusive, safe, resilient and sustainable” in the Sustainable Development Goals (SDGs) advocated by the United Nations.

In the foregoing, various embodiments have been described in detail, but the present invention is not limited only to the above-described embodiments, and includes various modifications. For example, in the above-described embodiments, the entire system has been described in detail so as to make the present invention easily understood, and the present invention is not necessarily limited to that including all the configurations described above. Also, part of the configuration of one embodiment may be replaced with the configuration of another embodiment, and the configuration of one embodiment may be added to the configuration of another embodiment. Furthermore, another configuration may be added to part of the configuration of each embodiment, and part of the configuration of each embodiment may be eliminated or replaced with another configuration.

### REFERENCE SIGNS LIST

1 . . . display apparatus (video display apparatus), 2 . . . retroreflection plate (retroreflective plate, retroreflector), 3 . . . space image (air floating video), 100 . . . transparent member, 101 . . . polarization separator, 11 . . . liquid crystal panel, 12 . . . absorptive polarization plate, 13 . . . light source apparatus, 21 . . . λ/4 plate, 200 . . . retroreflection module, 230 . . . user, 1190 . . . housing, 1351 . . . aerial operation detection sensor, 13A2 . . . regular video light, 13A4 . . . irregular video light

1. An air floating video display apparatus configured to display an air floating video, the air floating video display apparatus comprising:
a video display apparatus;
a polarization separator configured to reflect a video light of a specific polarized wave from the video display apparatus and transmit a video light of the other polarized wave;
a retroreflection module configured to retroreflect the reflected video light of the specific polarized wave from the polarization separator and convert it into a video light of the other polarized wave and including a λ/4 plate and a retroreflector; and
a housing configured to hold the video display apparatus, the polarization separator, and the retroreflection module,
wherein the video light of the other polarized wave from the retroreflection module is transmitted through the polarization separator to form the air floating video which is a real image at a predetermined position outside the housing, and
wherein, in a relationship between a first angle that the video display apparatus forms with respect to the polarization separator and a second angle that the retroreflection module forms with respect to the polarization separator, the second angle is different from the first angle.

2. The air floating video display apparatus according to claim 1,
wherein the second angle is larger than the first angle.

3. The air floating video display apparatus according to claim 1,
wherein the second angle is smaller than the first angle.

4. The air floating video display apparatus according to claim 1,
wherein a transparent member is provided in the housing so as to correspond to a region where the polarization separator is arranged, and a light-blocking portion is provided in a region that does not block the video light for forming the air floating video in a region through which an axis perpendicular to a surface of the retroreflection module passes.

5. The air floating video display apparatus according to claim 4,
wherein the transparent member is provided on a first housing surface in the housing and the light-blocking portion is provided on a second housing surface separated outward from the first housing surface by a predetermined distance.

6. The air floating video display apparatus according to claim 1, further comprising a holding unit configured to hold the video display apparatus, the polarization separator, and the retroreflection module so as to satisfy the relationship and fixed to the housing.

7. The air floating video display apparatus according to claim 6,
wherein the video display apparatus is attached to a first surface of the holding unit, the polarization separator is attached to a second surface of the holding unit, and the retroreflection module is attached to a third surface of the holding unit.

8. The air floating video display apparatus according to claim 7,
wherein the holding unit has a side surface portion configured to hold the first surface, the second surface, and the third surface, and
wherein a holding member configured to attach the retroreflection module so as to form the second angle is provided on the side surface portion.

9. The air floating video display apparatus according to claim 8,
wherein a holding member configured to attach the retroreflection module so as to form the second angle larger than the first angle is provided as the holding member on the side surface portion.

10. The air floating video display apparatus according to claim 8,
wherein a holding member configured to attach the retroreflection module so as to form the second angle smaller than the first angle is provided as the holding member on the side surface portion.

11. The air floating video display apparatus according to claim 8,
wherein a first holding member configured to attach the retroreflection module so as to form the second angle larger than the first angle and a second holding member configured to attach the retroreflection module so as to form the second angle smaller than the first angle are provided as the holding member on the side surface portion.

12. The air floating video display apparatus according to claim 11,
wherein the first holding member and the second holding member are parts having the same shape and structure.

13. The air floating video display apparatus according to claim 7,
wherein the holding unit has a side surface portion configured to hold the first surface, the second surface, and the third surface, and
wherein a rotation mechanism configured to attach the retroreflection module so as to form the second angle is provided on the side surface portion.

14. The air floating video display apparatus according to claim 13,
wherein the rotation mechanism has a rotation axis at a position that is coincident with a position of an optical axis of the reflected video light from the polarization separator.
